(19) United States
(12) Patent Application Publication
(10) Pub. No.: US 2013/0169541 A1
(43) Pub. Date: Jul. 4, 2013

(54) AERONAUTICAL INPUT/OUTPUT DEVICE WITH BIOMETRIC IDENTIFICATION MEANS

(71) Applicants: Ralf Cabos, Singapore (SG); Marie Kinkeldey, Tubingen (DE)

(72) Inventors: Ralf Cabos, Singapore (SG); Marie Kinkeldey, Tubingen (DE)

(73) Assignee: FLIGHT FOCUS PTE. LTD., Singapore (SG)

(21) Appl. No.: 13/635,191

(22) PCT Filed: Mar. 14, 2011
(86) PCT No.: PCT/IB11/51054

§ 371 Date: Nov. 16, 2012

(30) Foreign Application Priority Data
Mar. 15, 2010 (SG) 201001797-8

(51) Int. Cl. B64D 43/02

(52) U.S. Cl. CPC B64D 43/02
USPC 345/168; 705/342

(57) ABSTRACT

The application discloses an aeronautical input/output device (70) for flight task management which comprises a display unit (90) with a housing (97), and a keyboard unit (91) which is adapted to communicate with the display unit (90). The housing (97) comprises a keyboard stowage area (87) for receiving the keyboard unit (91) into the keyboard stowage area (87), and the keyboard unit (91) is detachable from or attachable to the display unit (90). Furthermore, the input/output device (70) comprises a biometric identification means with a biometric sensor (83) and an interface to a database, the database comprising an authorized users list (24). Therein, the biometric sensor (83) is provided on a casing of the aeronautical input/output device. A locking device (85, 98, 99, 101, 103) is provided for detachably fastening the keyboard unit (91) to the display unit (90) and is configured to unlock in response to a predetermined signal of the biometric identification means.

The present application relates to an aeronautical input/output device in a cockpit of an aircraft which is installed in addition to the standard flight equipment. The present application also relates to a method of using the aeronautical input/output device.

An aeronautical input/output device according to the application comprises an electronic information management and communication device that helps flight crews to perform flight management tasks easily and efficiently. The aeronautical input/output device is also a part of an onboard equipment in an aircraft, known as a pilot terminal unit. The aeronautical input/output device comprises furthermore an electronic flight bag (EFB) which is installed with electronic copies of aircraft operating manuals, flight crew operating manuals, navigational charts and other materials, which are normally carried onboard an aircraft as hard copy, paper-based products.

According to the application, the aeronautic input/output device also comprises a biometric identification means. Biometric identification technology is used increasingly for safety critical applications.

It is an object of the application to provide an improved aeronautic input/input device with a biometric sensor.

In particular, the application discloses an aeronautical input/output device for flight task management which comprises a display unit with a housing and with a keyboard unit which is adapted to communicate with the display unit. The aeronautical input/output device is located in the cockpit of an aircraft and the display unit is attached to a part of the cockpit, for example to the frame of a cockpit side window, or a wall of the cockpit.

The housing of the display unit comprises a keyboard stowage area for receiving the keyboard unit into the keyboard stowage area. The keyboard unit is detachable from or attachable to the display unit. In this way, the crew member can place the keyboard unit on his knees, for example, and is free to move around while accessing the keyboard unit. When the keyboard unit is not needed it can be stowed away easily and does not obstruct, which is particularly useful in the limited space of a cockpit.

Furthermore, the input/output device comprises a biometric identification means with a biometric sensor and an interface to a database, that comprises an authorized users list. The biometric sensor, which is also known as biometric device, is provided on a casing of the aeronautic input/output device. A locking device is provided for securing the keyboard unit to the display unit and is configured to unlock in response to a predetermined signal of the biometric identification means.

According to the application, a prior authorization via the biometric sensor is needed to unlock the keyboard unit when the keyboard unit is fastened to the display unit and locked to it with the locking device. In this way, a theft of the keyboard unit, for example by the cleaners, or an unauthorized access to the keyboard unit and to the flight information system can be prevented. In one embodiment, the biometric sensor is provided by a fingerprint sensor.

In addition, the biometric sensor provides an authorization for the access of electronic documents, an access to onboard applications and a digital signature for electronic documents and database entries. The access to the documents and onboard applications may be graded according to authorization levels which are stored with the authorized users list. In particular, the authorized users list may be provided in a computer readable memory within the display unit. In another embodiment, the authorized users list is provided in a computer readable memory on the aircraft, for example on a computer that is stored in a computer rack in the electronic bay on the aircraft.

In an authorization process according to an embodiment of the application, a sensor signal is processed in an electronic circuitry of the keyboard to obtain a digital representation of a biometric identifier. The circuitry may comprise a data processor. The processed data which comprises the digital representation is sent to an antenna of the display unit via a keyboard antenna. In the display unit, an onboard application uses the processed data for comparison with an authorized users list. If the processed data can be matched with an entry of the authorized users list, an identification signal is sent to the keyboard unit. In response to the identification signal, an actuator is used to unlock the locking device. For example, the actuator may comprise a mechanical lever with an electric motor, an electromagnet or a combination of both. The matching that triggers the identification signal may be exact or within a predetermined accuracy.

According to the application, the biometric identification means is configured to derive a digital representation of a biometric identifier and is furthermore configured to derive the predetermined signal from the digital representation of the biometric identifier. The biometric identifier may comprise a fingerprint, a palm pattern, a retina pattern, an iris pattern, a voice pattern or a behavioural pattern, for example. Criteria for choosing a specific pattern are, among others, uniqueness, low probability of failure, user acceptance and the robustness and price of the sensor.

In one embodiment, the keyboard unit comprises an antenna or a transceiver with antenna for establishing a radio link to the display unit. Furthermore, the keyboard unit comprises an electronic circuitry which is connected to the antenna and a rechargeable current supply which is connected to the electronic circuitry. A charging plug is connected to the rechargeable current supply in the keyboard unit and the charging plug matches with a charging socket on the display unit. In this way, an energy supply for the biometric sensor and for reading in keypad signals is provided. According to the application, no disposable batteries are needed and it is also not necessary to remember recharging, as the recharge-able power supply will always be charged when the keyboard unit is stowed away in the display unit between flights or flight legs.

In one specific embodiment, the locking device is designed as a mechanic lock which comprises a swivel type catch with an actuator, wherein the actuator is connected to electronic circuitry of the aeronautical input/output device. The electronic circuitry is configured to generate the predetermined signal in response to a digital representation of a biometric identifier. The swivel type catch can be locked in a locking position by the actuator. The mechanic lock may also comprise a spring for providing a restoring force. The mechanical lock can be designed sturdy or in a way that it can still be opened, even if the actuator fails.

In another embodiment, the locking device comprises a magnetic catch with an actuator that is connected to electronic circuitry of the aeronautical input/output device and the electronic circuitry is configured to generate the predetermined signal in response to a digital representation of a biometric identifier. The magnetic catch may comprise a permanent magnet which is moved to a locking position or an electromagnet and a spring which provides a restoring force. A magnetic lock according to the application may be designed in such a way that there are no moving parts outside the casings such that it cannot easily be opened by a force from outside.

According to the application, the biometric sensor may be placed in such a way that it is still accessible when the keyboard unit is stowed away in the display unit. This can be achieved by placing the biometric sensor at a backside of the keyboard unit, by placing the biometric sensor at the housing of the display unit (for example, either on the top of the display unit, on the sides, or on the bezel).

In addition, the locking device may be configured to lock in response to a predetermined signal of the biometric identification means. In this way it is prevented that an unauthorized person can lock the keyboard unit in the display unit.

In one embodiment, the aeronautic input/output device is designed in such a way that the keyboard stowage area comprises a concave side and the keyboard housing comprises a convex side. The convex side and the concave side have an essentially mating shape for storing the keyboard unit (91) in the keyboard stowage area (87). For rounded shapes like concave/convex shapes the storing of the keyboard unit in the keyboard stowage area is easy to achieve since it is not necessary to insert the keyboard unit in an exact 90° angle. The matching shapes can be designed in such a way that the outer surfaces of the casings are flush when keyboard unit is inserted into the display unit. In this way, injuries on protruding parts can be prevented.

In a particular embodiment of an aeronautical input/output system with an aeronautical input/output device, the authorized user list is provided in a memory of the display unit or of the keyboard unit. A provision in the keyboard unit provides faster processing without the need of using a radio link while a provision in the housing of the display unit provides greater safety of the stored data. Moreover, a microprocessor in the display unit can have a higher performance because the display unit does not have to be as light and the display unit has a permanent power supply.

In this particular embodiment, the aeronautical input/output comprises at least one data processing unit and at least one computer readable memory, the computer readable memory comprising the database with the authorized users list, the data processing unit and the computer readable memory being connectable to each other and at least one data entry of the authorized users list comprising a digital representation of a biometric identifier.

Advantageously, the aeronautical input/output system comprises means for updating the authorized users list with a ground based system. In this way, the authorized users list can be provided from the ground based system. In addition, the aeronautical input/output system may also provide means to alter the authorized user list by using input/output means of the aeronautical input/output device. The altering of the authorized users list may require an administrator password or a biometric identifier of an authorized person with administrator rights.

Advantageously the aeronautical input/output system comprises aircraft communication connections for communication with a ground-based system. In this way it is not necessary to bring a data carrier with an authorized users list to the aircraft in order to update the authorized user list. According to the application, the aircraft communication system is also used to retrieve further information such as weather data, NOTAMS, airline data etc. The application furthermore discloses a method for generating a signed entry in a defect log of an aircraft that is stored in a computer readable memory of an aeronautical/input output system. An entry to the defect log is received via an aeronautic input/output device and the entry is added to the defect log. A priority grading of the entry is received via the aeronautic input/output device and a predetermined digital representation of a biometric feature is received via a biometric identification means. A signed priority grading is derived from the priority grading and the digital representation the signed priority grading is stored with the entry. According to the application, the priority grading may be used to send a predetermined message which is based on the priority grading. For example, an immediate order of a part may be required such that the part is already available at the next stop of the aircraft. Herein and in the following, the term “predetermined digital representation” means that the digital representation automatically derived raw data of a sensor by a predetermined method, for example by extraction of minutiae.

Not only the grading of the defect log entry may be digitally signed but also the defect log entry itself. In one embodiment, predetermined digital representation of a second biometric feature is received via the biometric identification means. A signed entry is derived from the entry and the digital representation of the second biometric feature and the signed entry is added to the defect log.

The application discloses furthermore a method for distributing a digitally signed load and balance sheet from an aircraft (11). Loading data is received from a ground based airline office. An onboard application is used to generate a load sheet and a predetermined digital representation of a biometric feature is received via a biometric identification means. A digitally signed load and balance sheet is generated using the digital representation of the biometric feature. The digitally signed load and balance sheet is passed to aircraft based communication means. The communication means are also referred to as communication connections. A similar method can also be used for the distribution of a digitally signed flight plan.

Furthermore, the application discloses a method for distributing a digitally signed fuel order from an aircraft. An onboard application is used to calculate a required amount of fuel. A predetermined digital representation of a biometric feature is received via a biometric identification means and a digitally signed fuel order is generated using the digital representation of the biometric feature. The digitally signed fuel order is passed to communication means of the aircraft.

A method for unlocking a keyboard unit from a display unit of an aeronautical input/output device comprises the following steps. A predetermined digital representation of a biometric feature is derived from an input signal of a biometric sensor which is provided at a casing of the aeronautical input/output device. The digital representation is compared with entries of an authorized user list (24) in a computer readable memory. If the digital representation matches an entry of the authorized users list an actuator of a locking device of the keyboard unit is actuated to unlock the keyboard unit.

According to the application, the aeronautical input/output device comprises a processing unit which hosts purpose-built software applications to automate other functions normally conducted on the ground, such as flight planning and take-off calculations. Due to the nature of the operating environment in a cockpit of the aircraft, the aeronautical input/output device must be able to operate at environmental conditions which are required by regulatory authorities.

This application provides an aeronautical input/output device that has a display unit in the cockpit of the aircraft, for storing and displaying documents and manuals. The aeronautical input/output device is alternatively known as a pilot terminal device or an electronic flight bag, or an electronic flight bag display device. The aeronautical input/output device can contain a range of functions and software applications. For example, the aeronautical input/output device can have flight planning applications, applications for compiling pilot briefing materials, and applications for performing takeoff calculations. The aeronautical input/output device can also function as a communication interface device, which enhances flight safety with global communications coverage, and provides alternative communications methods for the flight crew to use, thereby maximising bandwidth usage and minimising costs.

The present application provides a device which alerts flight crews or other users to the arrival of incoming messages through indicator lights that flash in a certain sequence, depending on the type of message being received.

A device can be provided by the present application for storing aviation data and information. The device may also be used as a communications device, which contains applications and functionalities useful to the flight crews in performing their duties. The device, as provided by the application, may also incorporate a moving map display, and provides aviation data and information, which may be displayed together in a geo-referenced display. Data and information in the device may be able to be dynamically updated throughout all stages of a flight.

According to the application, there is provided an aeronautical input/output device for flight task management that comprises a display unit and a keyboard unit. The keyboard unit differs from a touch-screen keyboard that can be displayed on the display unit. The display unit has a housing that encloses its electronic components. The keyboard unit is electrically connected to the display unit such that the keyboard unit can communicate with the display unit via cables or wirelessly. The wireless communication may also be termed as cordless communication. The housing comprises a keyboard stowage area, which is in the form of one or more recesses, cavities or pockets. The keyboard stowage area is provided for receiving a detachable keyboard unit. In other words, the keyboard unit can be received into the keyboard stowage area for attaching the keyboard unit to the display unit for storing and/or charging. The keyboard unit can also be detached from the display unit for data input by the flight crew or other users.

Since the keyboard unit can be stored into the recess of the display unit, the aeronautical input/output device becomes compact. As a result, the aeronautical input/output device occupies little space such that neither pilots' movements and views, nor their egress (should this be required) are obstructed. Due to its compactness, the aeronautical input/output device can be installed in the cockpit, which brings much flexibility to applications and maintenance.

A housing of the display unit can be hermetically sealed for preventing the display unit from ingress of dust and liquids. In the event that liquids are accidentally spilled over the display unit, a sealing of the housing prevents the liquids, which would be hazardous to the electronic components in the display unit, from reaching the interior of the display unit so that the aeronautical input/output device can function with a high degree of reliability.

Moreover, the housing can be made of a material with good thermal conductivity, such as an aluminium alloy. The aluminium alloy draws heat away from an interior of the display unit efficiently and dissipates the heat to the surrounding environment. The heat dissipation can be further enhanced by providing internal contacts between the housing and heat generating components. The aluminium alloy also provides strong structural support and protection in the form of a shell against mechanical shocks, which can occur with turbulent weather conditions or heavy landings.

The housing can further comprise cooling fins that extend from the housing. The cooling fins provide expanded surfaces for convection and radiation that improve the heat dissipation. The cooling fins can follow external profiles of the housing, thereby preserving compactness of the display unit. The cooling fins can be arranged into one or more arrays on the housing. In other words, the application provides a sealed unit with conduction cooling.

The display unit may be configured to communicate with the keyboard unit wirelessly. The wireless communication removes electrical cables that otherwise link the display unit and the keyboard unit. Electrical cables may be obstructive and may cause interference with the aircraft controls mounted in proximity to the aeronautical input/output device. The wireless communication also provides a neat outlook to the aeronautical input/output device. An example of implementing the wireless communication is using Bluetooth that is suitable for communication in the cockpit, and for connection with a ground-based operation centre via a secure data link.

The display unit can comprise one or more data processing units and one or more data storage devices that are connected to each other for computing. The data processing unit is also known as a processor. For example, the display unit may contain a central processing unit (CPU) and a solid state drive (SSD), which are connected together to form a computer. Alternatively, the input/output devices may be individually connected to a central processing unit located in another part of the aircraft. The display unit can be fixed in the cockpit. The display unit becomes useful for a flight crew to carry out various tasks when having computing and data storage capabilities located in proximity to them in the cockpit.

As a computing device, the display unit can further comprise one or more universal serial bus (USB) ports that are electrically connected to the one or more data processing units and to the one or more data storage devices for uploading and downloading data to and from the aeronautical input/output device. The USB port provides an easy connection to the aeronautical input/output device for data exchange with a large bandwidth.

The display unit can comprise aircraft communication connections for communication with a ground-based system, the keyboard unit, or both of them wirelessly. The aircraft communication connections comprise one or more of a universal serial bus (USB) port, an Iridium Satellite Network connection, a Bluetooth connection. The wireless connection enables the aeronautical input/output device to stay connected regardless of the location of the aircraft: either in the air or on the ground.

The display unit can comprise a touch-screen that enables intuitive operations of the aeronautical input/output device by the pilot. The touch-screen can either be operated by a finger, a stylus or other touching devices. In other words, the touch-screen forms a part of a user interface for the selection of onscreen features and inputting of data.

The keyboard unit comprises a keyboard housing with two leg rest cavities for placement on thighs of a user respectively. The leg rest cavities can be placed on a broad side of the keyboard unit, which is a base of the keyboard unit for supporting the unit whilst it is operation. Keyboard buttons of the keyboard unit are on an opposite side of the base. The leg rest cavities can fit across the lower thighs of a user. When the user is in a seated position, the leg rest cavities sit on top of the user's thighs and provide a stable support to the keyboard unit for data input.

In one embodiment, the keyboard housing can be hermetically sealed. For example, the keyboard buttons are formed integrally as parts of keyboard housing so that no gap is left for the ingress of liquids, dust or other foreign objects. Moreover, the keyboard unit comprises a keypad that is hermetically sealed. Keyboard buttons of the keyboard unit are formed integrally as parts of the keyboard unit so that no gap is left for liquid intrusion.

In a further embodiment, the keyboard unit comprises a display screen for displaying contents that are substantially the same as shown on the display unit. The display screen is located on the keyboard unit so that the pilot can avoid looking at the display unit when making data entry into the system. The display screen provides an overview of what is shown on the touch-screen so that an overall functionality of the keyboard unit is enhanced. If necessary, the display screen can also display contents that are different from what is shown on the display unit.

This arrangement alleviates the pilot from having to look at the display unit and the keyboard unit simultaneously at different locations whilst inputting data into the system. Sometimes, when the display unit is mounted on a side window of the cockpit, it can be awkward and not ergonomically suitable for the pilot to observe the display unit and the keyboard unit at the same time. Thus, the display screen on the keyboard unit makes the display unit much easier to use.

The display screen on the keyboard unit may comprise a touch-screen. The pilot can either use his fingers or a stylus to interact with the touch-screen. The keyboard unit can further provide a slot for keeping the stylus when the stylus is not in use. Being a touch sensitive screen, the display screen is intuitive to use by the pilot.

The aeronautical input/output device can comprise one or more light sensors that are connected to the one or more data processing units for automatically adjusting brightness of the display unit or the display screen automatically. The light sensors can be installed onto the display unit, the keyboard unit, or both.

The light sensors are ambient light sensors, which detect an amount of light in the cockpit environment and cause the aeronautical input/output device to adjust the brightness of the screen/s in accordance with pre-defined parameter settings. The aeronautical input/output device can regulate brightness of the display unit, the display screen, or both in response to ambient light conditions such that viewers of the aeronautical input/output device are not required to adjust the brightness when the cockpit environment is in daytimes or nighttimes.

An embodiment of the application provides a biometric identification means comprising a biometric sensor at the keyboard unit, the display unit or both for user authentication. The biometric device uniquely recognises intrinsic physical or behavioural traits of a human. For example, the biometric device comprises a scanner for reading fingerprints of users so that the users can be reliably identified for authorising their operation of the aeronautical input/output device. The biometric device avoids requesting the users to remember passwords and regular updates of the passwords, and makes the display unit less prone to erroneous use.

The display unit may comprise a keyboard charging socket and the keyboard unit may comprise a keyboard charging plug such that the keyboard charging socket and the keyboard charging plug can connect to each other for charging a battery in the keyboard unit. The display unit can receive electricity from an electrical supply of the aircraft. The battery is charged when the socket and the plug are coupled. The socket and plug obviate cables to make the coupling and they are integral to their host. The integral connectors help to keep compactness of the aeronautical input/output device.

An embodiment of the application provides the display unit that comprise an Electronic Flight Bag of class two, or of class three. The Electronic Flight Bag includes computer parts, such as one or more processors, a non-volatile solid-state memory, and a volatile solid-state memory. The Electronic Flight Bag can thus be loaded with various purpose-built software applications to automate functions previously conducted manually, such as takeoff calculations. The solid-state memory can further store Aircraft Operating Manuals, Flight Crew Operating Manuals and Navigational Charts and other electronic documents. The solid-state memory can withstand vibrations and accelerations of the aircraft with no compromise in its computing performance.

A further embodiment of the application provides the aeronautical input/output device with lockers or locking devices for securing the keyboard unit to the display unit. The lockers or locking devices can be mechanical, electrical, or in combination of any of these. Forms of the locker include a cord lock type, a fastener type, an end clasp type, a clip type, a snap type or a stopper type.

The locker can comprise a latch or a locking clip that is mounted onto the input/output device for attaching the keyboard unit to the input/output device. The input/output device is also known as a display unit. The latch comprises a handle that is rotatable between a first position for supporting the keyboard unit and a second position for releasing the keyboard unit. In other words, the latch or the locking clip is known as a swivel type of catch, which is movable to attach the keyboard unit to the display unit. The handle can be moved easily between the two positions for the supporting or the releasing of the keyboard unit. The latch has a simple and robust structure for low production cost and long-term usage.

In another embodiment, the locker or the latch comprises a retractable catch on the housing of the display unit. The retractable catch retreats into the housing when the keyboard unit strikes the retractable catch for attaching the keyboard unit to the display unit. The retractable catch extends when the keyboard unit is removed from the keyboard stowage area.

The keyboard stowage area can comprise a concave side and the keyboard housing can comprise a convex side such that the concave side and the convex side can match closely for storing the keyboard unit in the keyboard stowage area. In other words, the convex side and the concave side match to each other for joining. The two sides provide close contacts in-between so that the keyboard unit fits into the housing in making one integral device. The aeronautical input/output device thus provides a complete, compact and efficiently packaged unit.

To guide the attaching of the keyboard unit, the display unit can comprise guide rails that guide insertion of the keyboard unit into the display unit, and act as an additional means of securing the keyboard unit to the input/output device. The guide rails also prevent excessive insertion of the keyboard unit by setting boundaries of the keyboard stowage area for receiving the keyboard unit.

The present application also provides a method of using an aeronautical input/output device. The aeronautical input/output device comprises a keyboard unit and a display unit. The method comprises a step of detaching the keyboard unit away from the display unit for data entry, and a step of attaching the keyboard unit to the display unit for storage or charging. The charging replenishes the battery of the keyboard unit for a wireless communication mode. The wireless communication mode provides convenience to a pilot. The pilot can take the keyboard unit away from the display unit and put it on his lap for data entry. The pilot can also attach the keyboard unit to the display unit for storage. Since the keyboard unit is stored together with the display unit, the pilot can easily locate the keyboard unit at any time because the keyboard unit is always kept at a designated place on the display unit and is required to be stowed for landing and take-off.

The application further provides a method of installing an aeronautical input/output device in a cockpit of an aircraft. The aeronautical input/output device comprises a keyboard unit and a display unit. An installation procedure comprises a step of mounting the display unit to a supporting frame in the cockpit of the aircraft, and a step of attaching a keyboard unit to the display unit for storing the keyboard unit. The keyboard can be detached away from the display unit for data entry and attached to the display unit for charging the keyboard unit.

The aeronautical input/output device when installed as either a Class two or a Class three device is connected to an aircraft power supply and to other aircraft components such as a central processing unit, communications device located in the ceiling of an aircraft cockpit and to a satellite communications antenna.

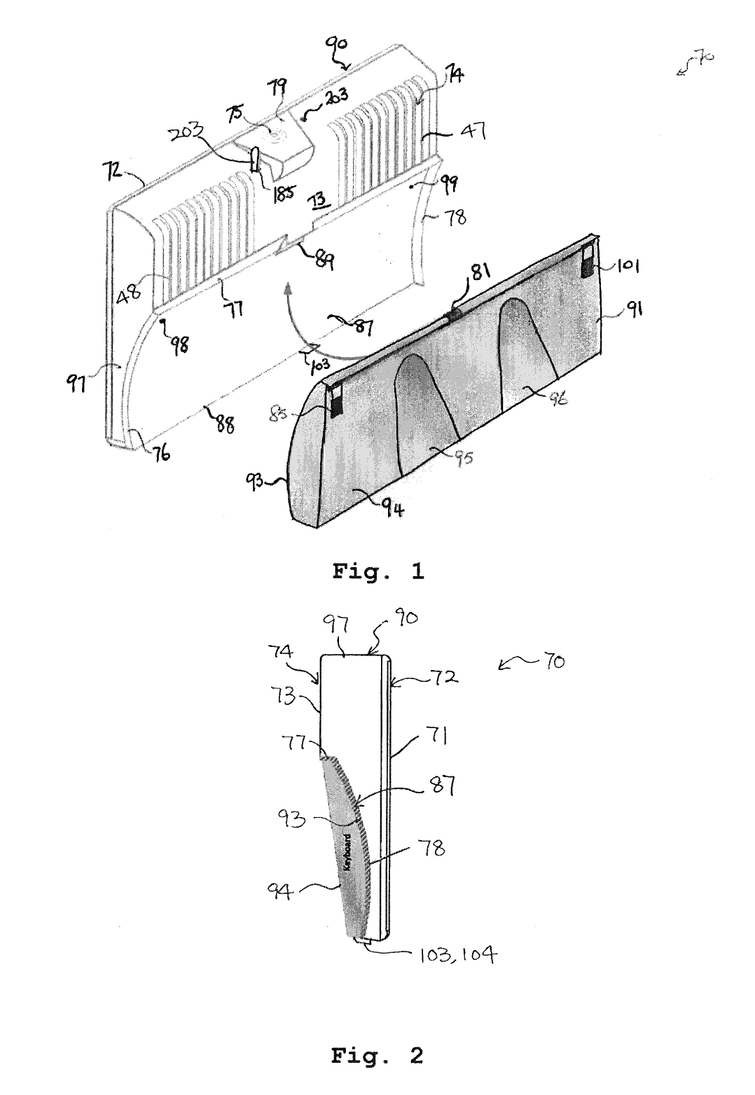

FIG. 1 illustrates an exploded view of an aeronautical input/output device,

FIG. 2 illustrates a side view of the aeronautical input/output device,

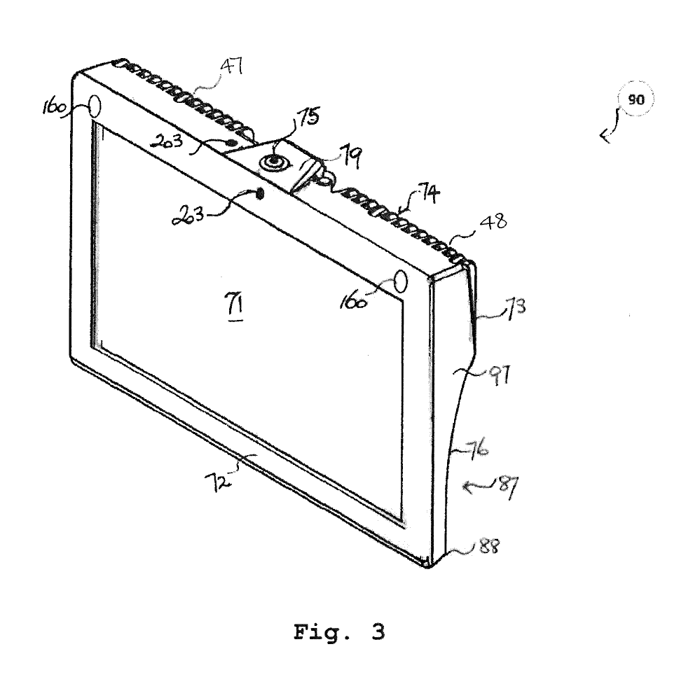

FIG. 3 illustrate a perspective view of a touch-display unit of the aeronautical input/output device,

FIG. 4 illustrates a perspective view of a keyboard unit of the aeronautical input/output device,

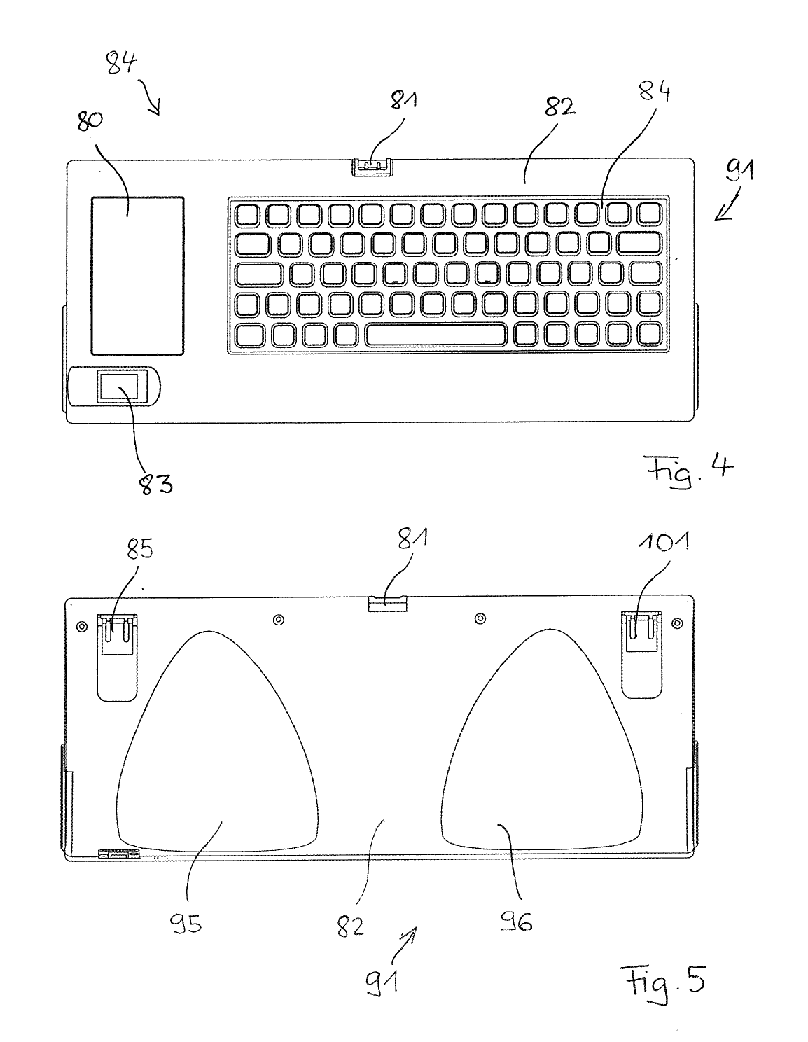

FIG. 5 illustrates a back view of the keyboard unit,

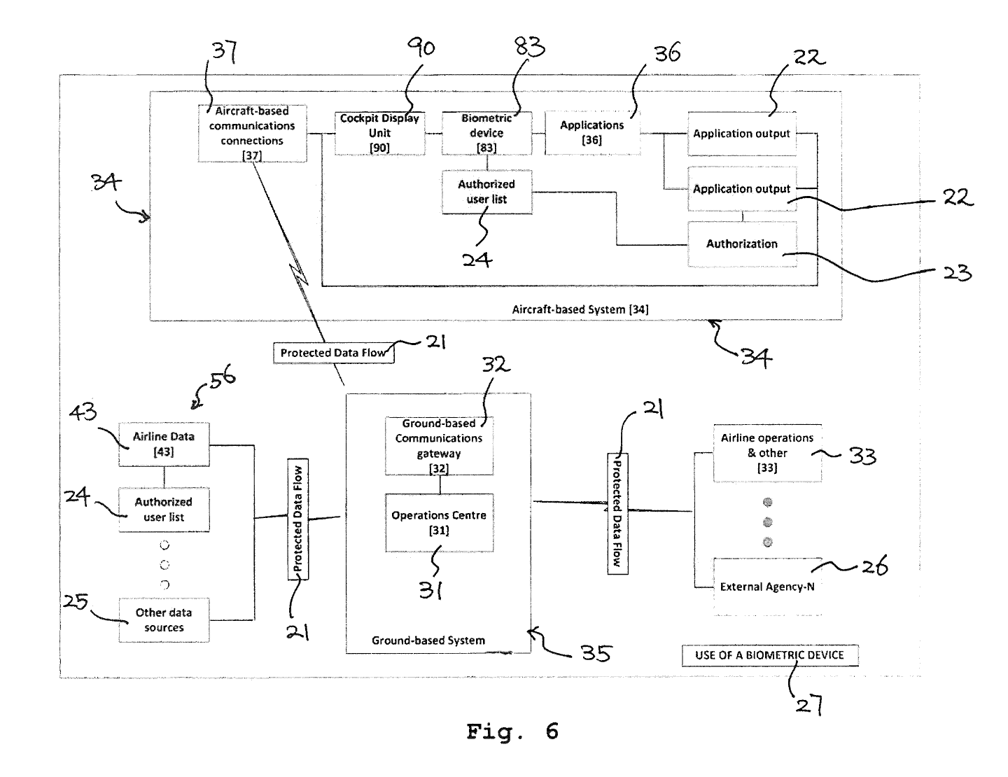

FIG. 6 illustrates a workflow and connectivity for the use of a biometric device,

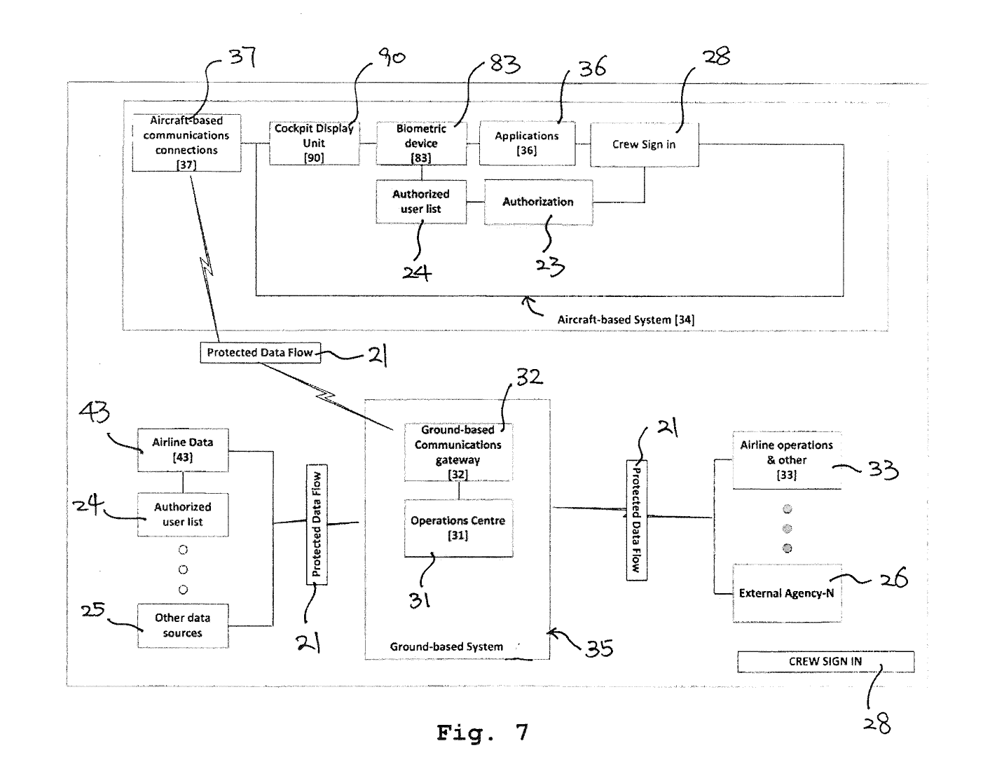

FIG. 7 illustrates the workflow and connectivity associated with Crew sign in,

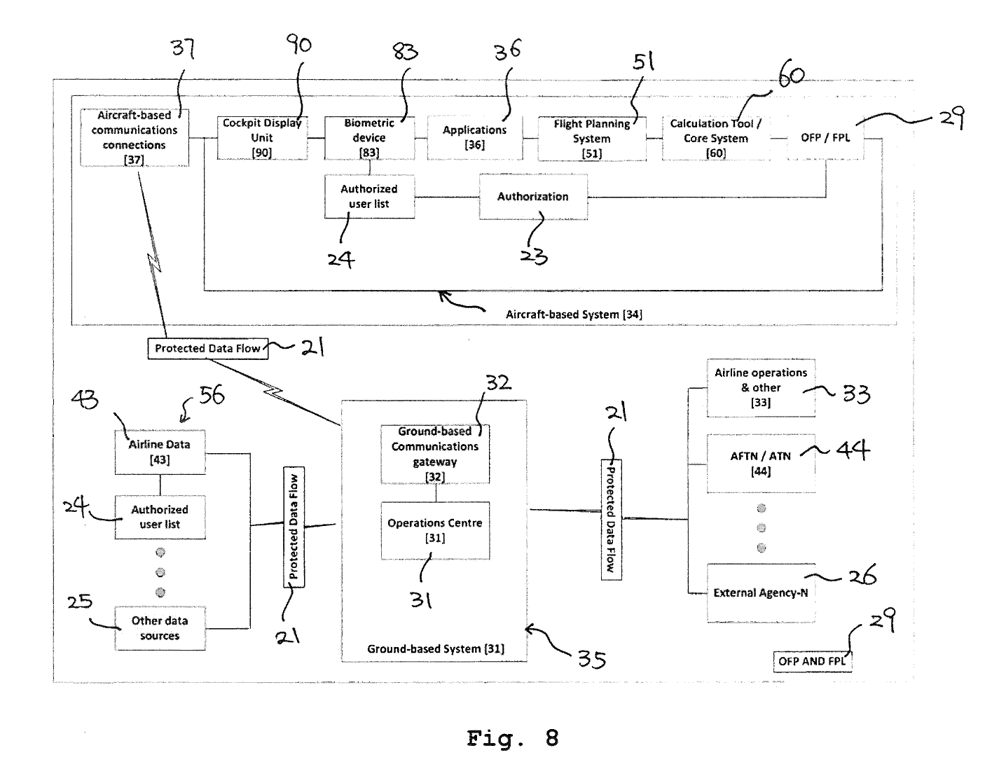

FIG. 8 illustrates the workflow and connectivity associated with the construction and dispatch of OFP (Operational Flight Plan) and FPL (Flight Plan),

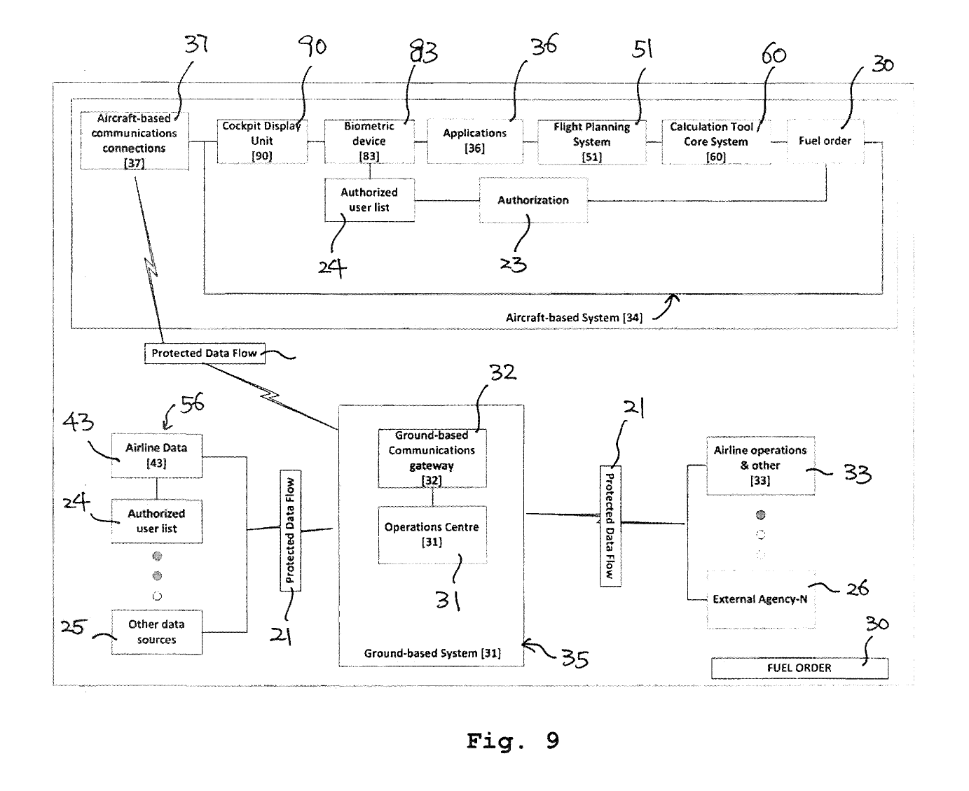

FIG. 9 illustrates the workflow and connectivity associated with the preparation and dispatch of a Fuel Order,

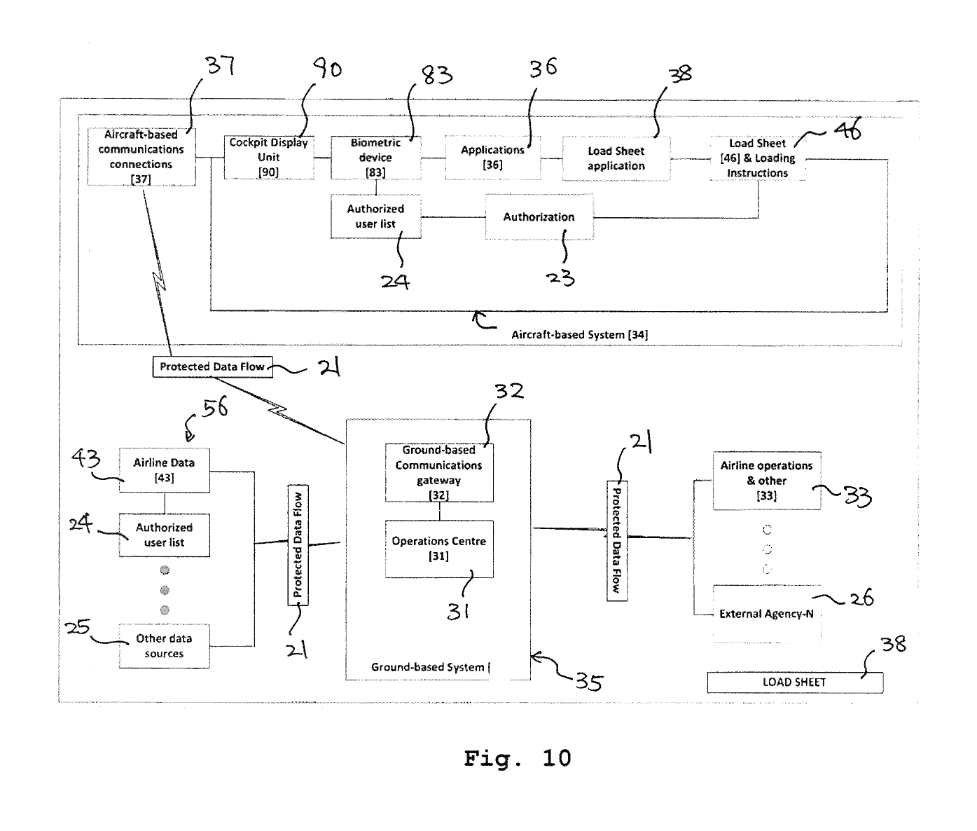

FIG. 10 illustrates the workflow and connectivity associated with the preparation of a Load Sheet and Loading instructions,

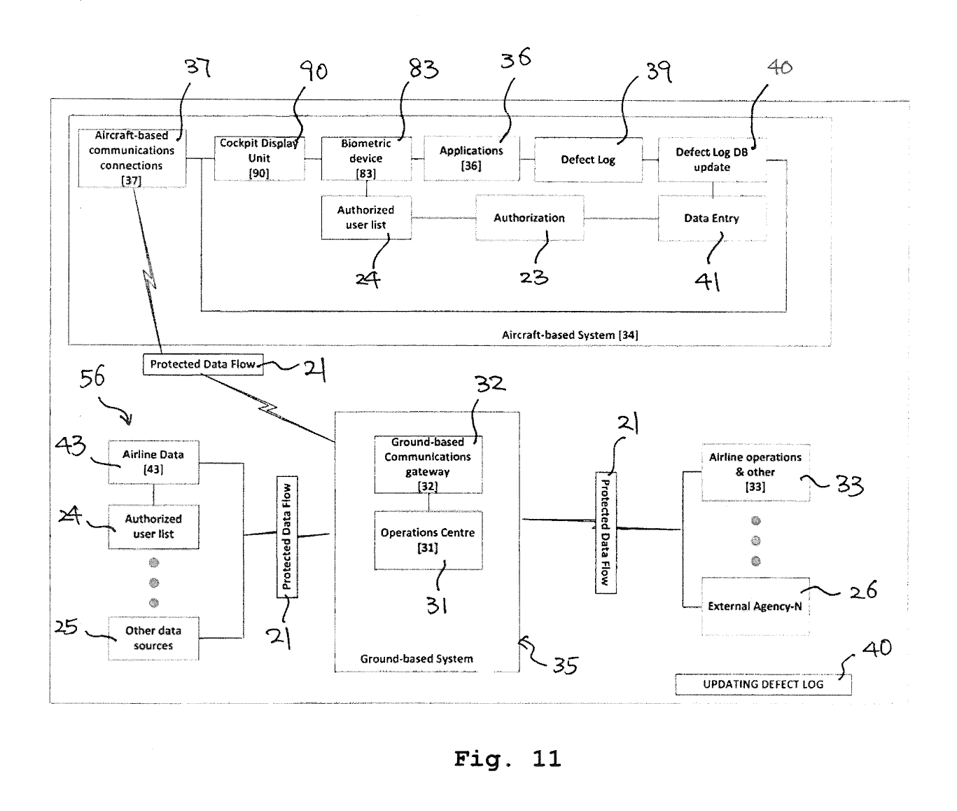

FIG. 11 illustrates the workflow and connectivity associated with updating an aircraft Defect Log,

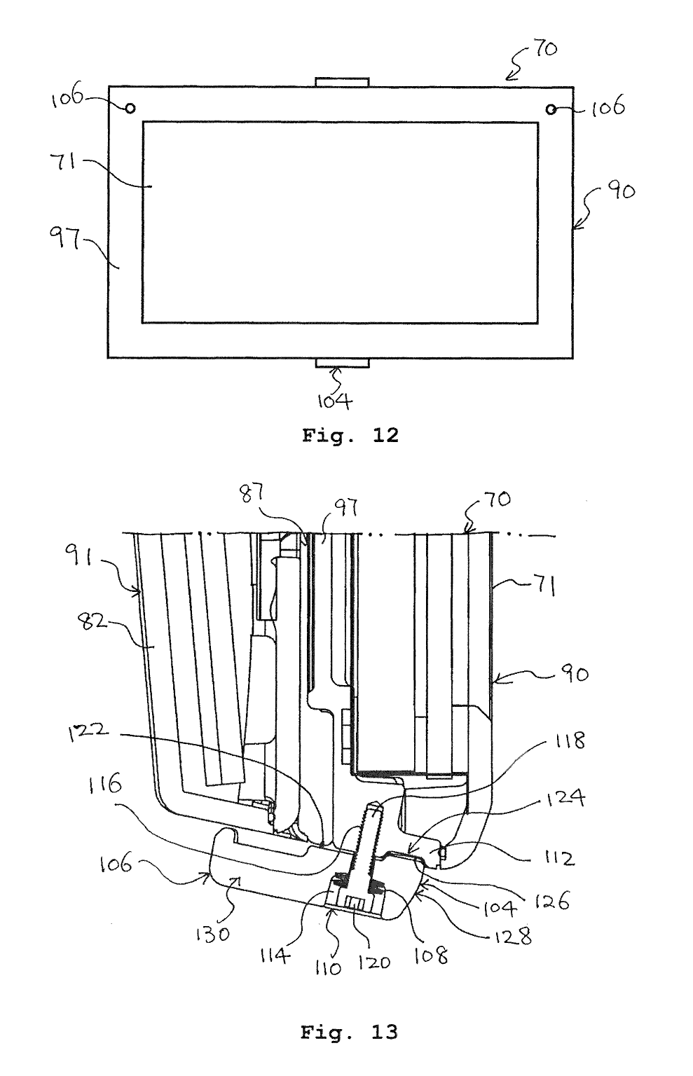

FIG. 12 illustrates a front view of an aeronautical input/output device with a latch,

FIG. 13 illustrates a sectioned view of the latch,

FIG. 14 illustrates an isometric view of a handle of the latch,

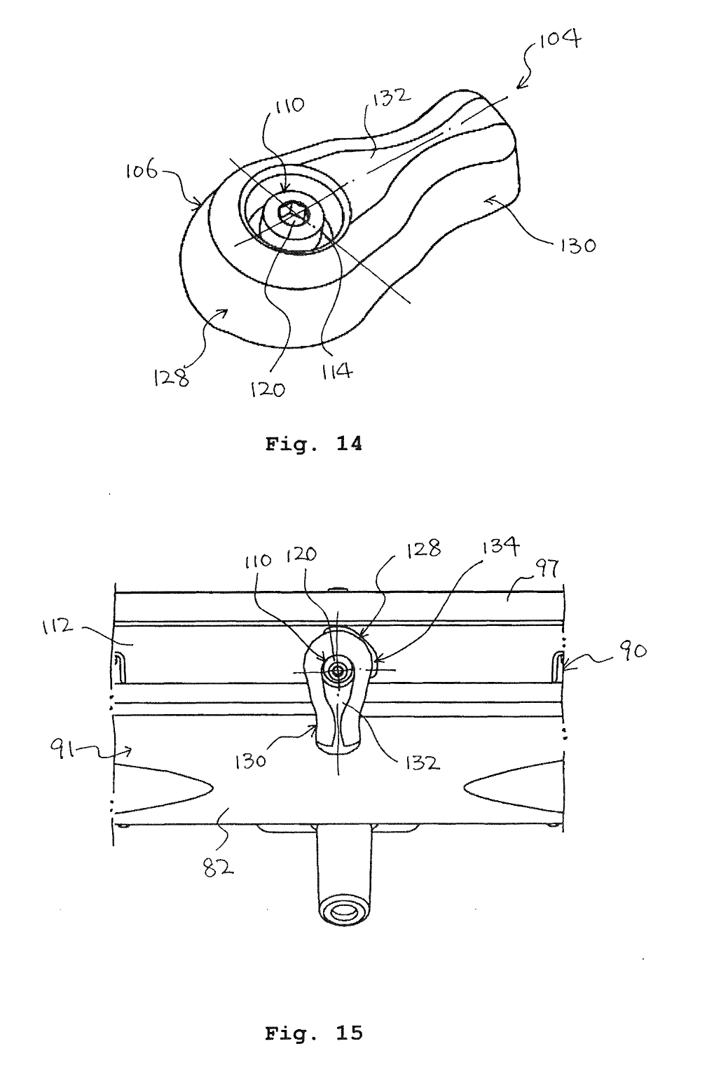

FIG. 15 illustrates a bottom view of the aeronautical input/output device in a latched position,

FIG. 16 illustrates a side view of the aeronautical input/output device in the latched position,

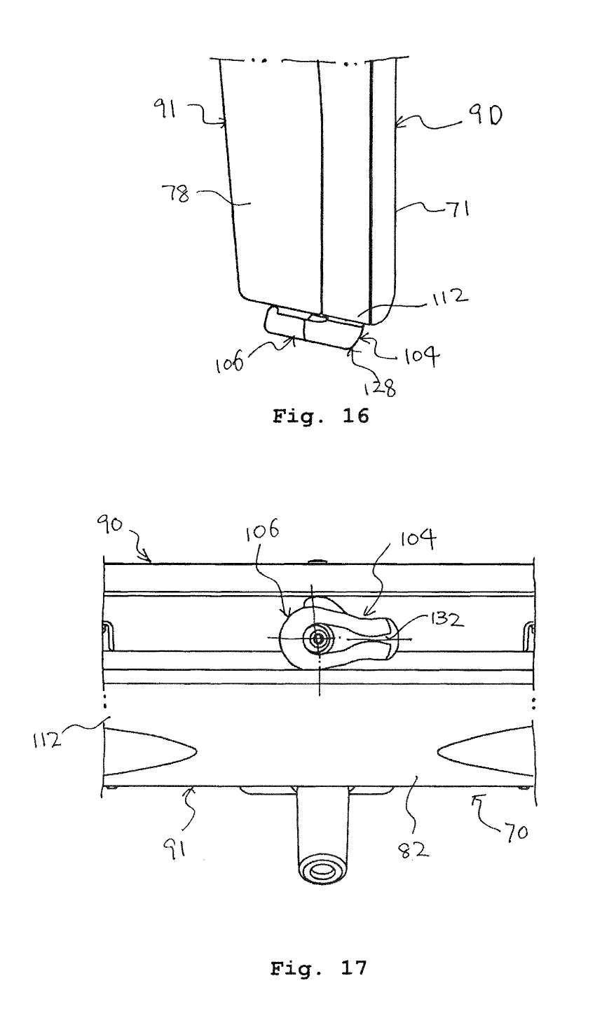

FIG. 17 illustrates a bottom view of the aeronautical input/output device in an unlatched position,

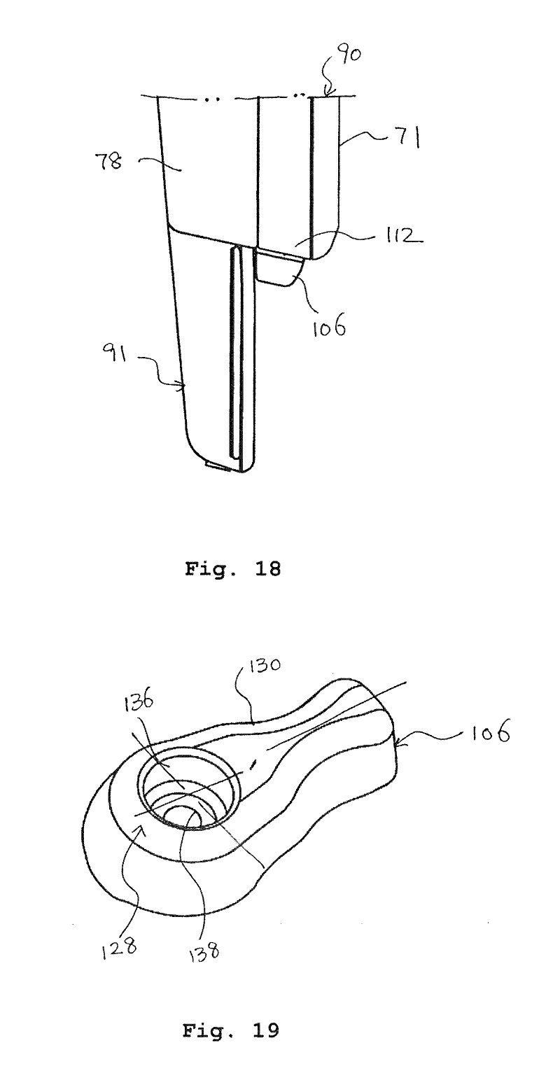

FIG. 18 illustrates a side view of the aeronautical input/output device in the unlatched position,

FIG. 19 illustrates an isometric view of another handle for the latch,

FIG. 20 illustrates a back view of the aeronautical input/output device in an assembled position,

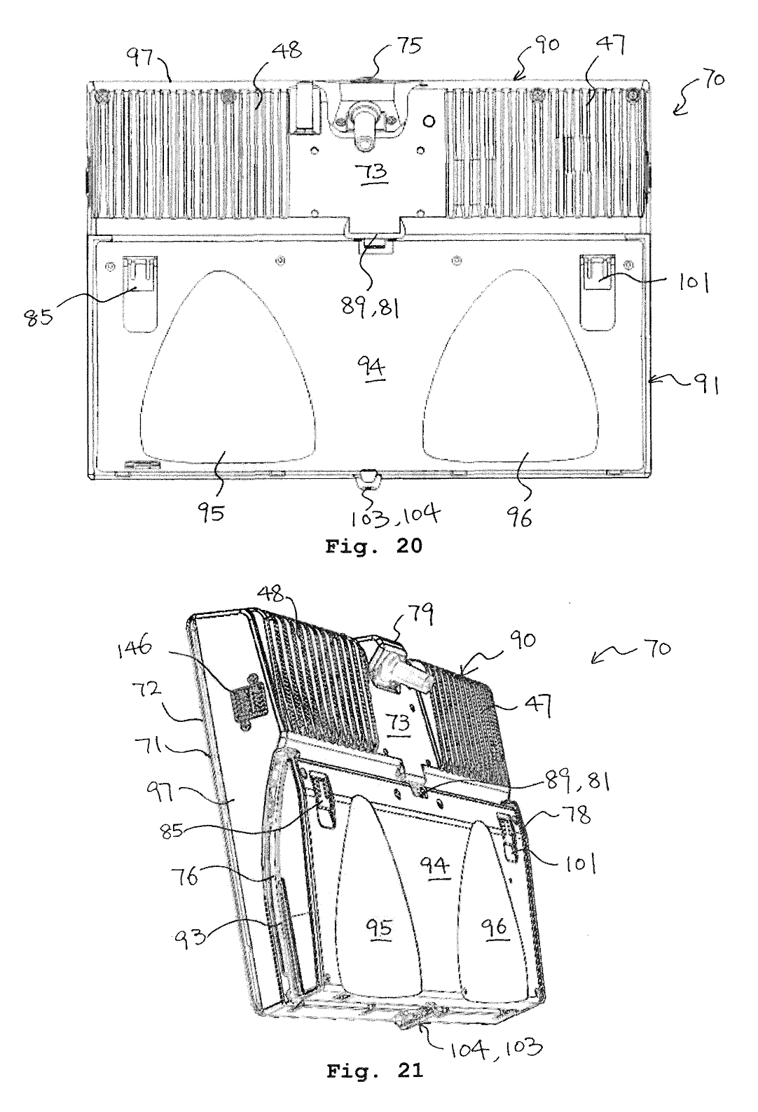

FIG. 21 illustrates a perspective view of the aeronautical input/output device from its back,

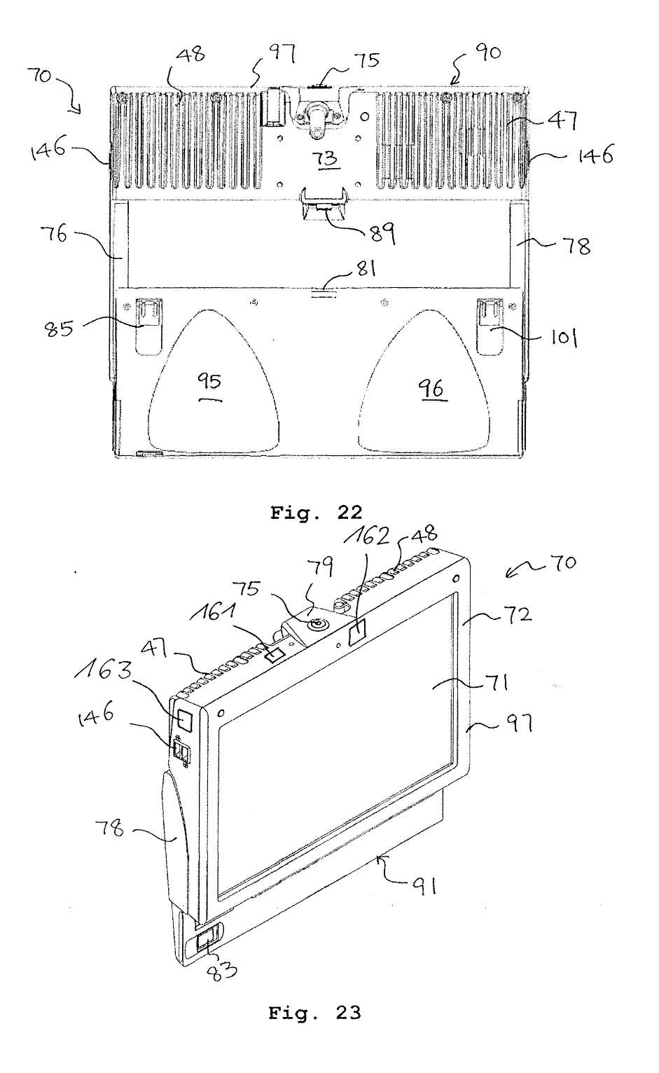

FIG. 22 illustrates a back view of the aeronautical input/output device whose keyboard unit is semi-detached,

FIG. 23 illustrates a front isometric view of the aeronautical input/output device whose keyboard unit is semi-detached,

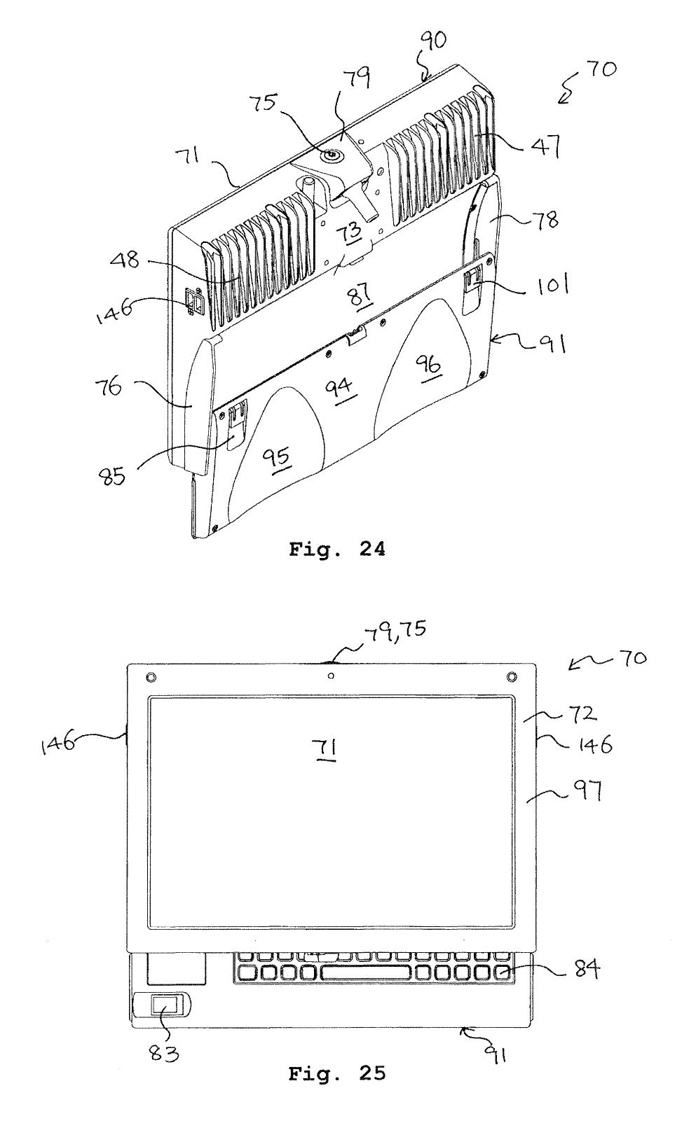

FIG. 24 illustrates a back isometric view of the aeronautical input/output device whose keyboard unit is semi-detached,

FIG. 25 illustrates a front view of the aeronautical input/output device whose keyboard unit is semi-detached,

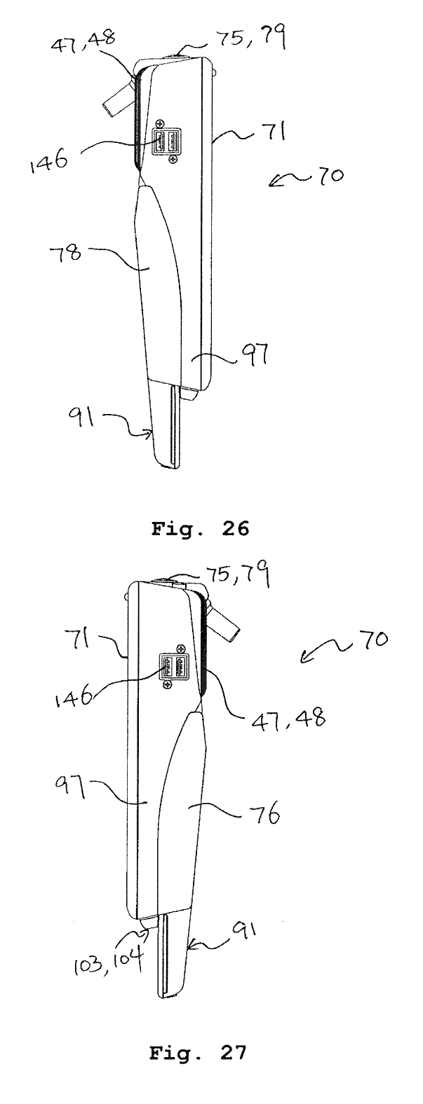

FIG. 26 illustrates a first side view of the aeronautical input/output device whose keyboard unit is semi-detached,

FIG. 27 illustrates a second side view of the aeronautical input/output device whose keyboard unit is semi-detached,

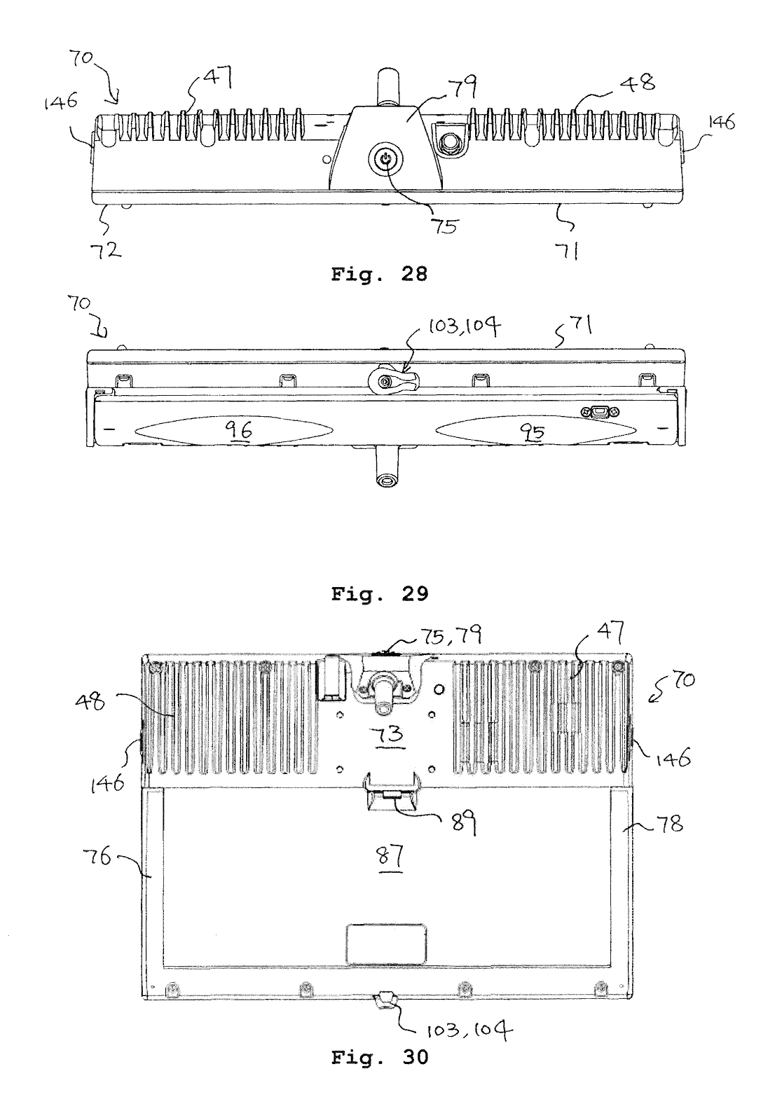

FIG. 28 illustrates a top view of a touch screen display unit,

FIG. 29 illustrates a bottom view of a touch screen display unit,

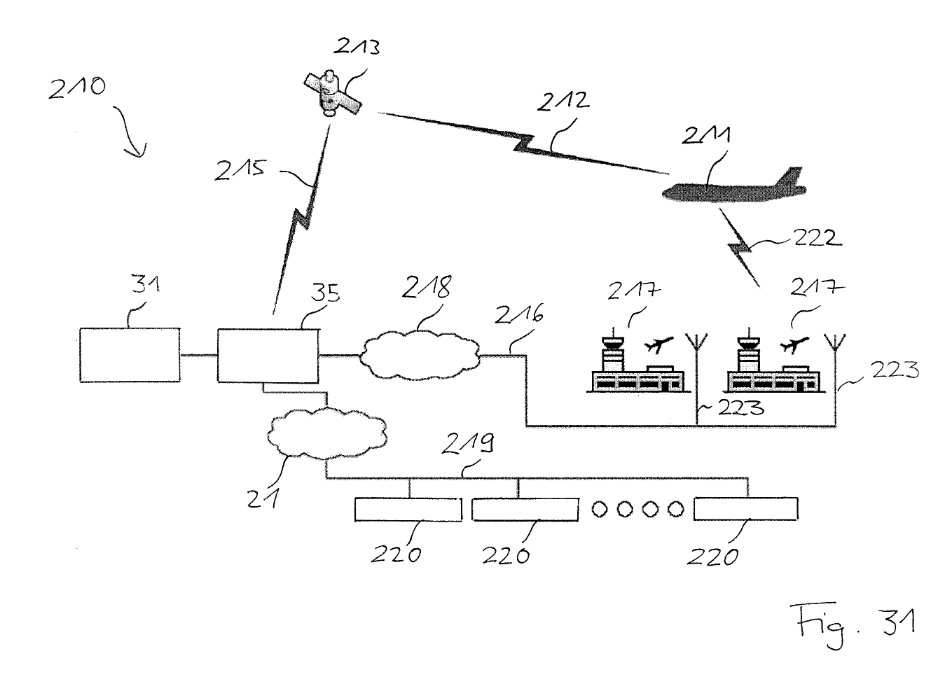

FIG. 30 illustrates a back view of the touch screen display unit, and

FIG. 31 illustrates a flight information exchange system,

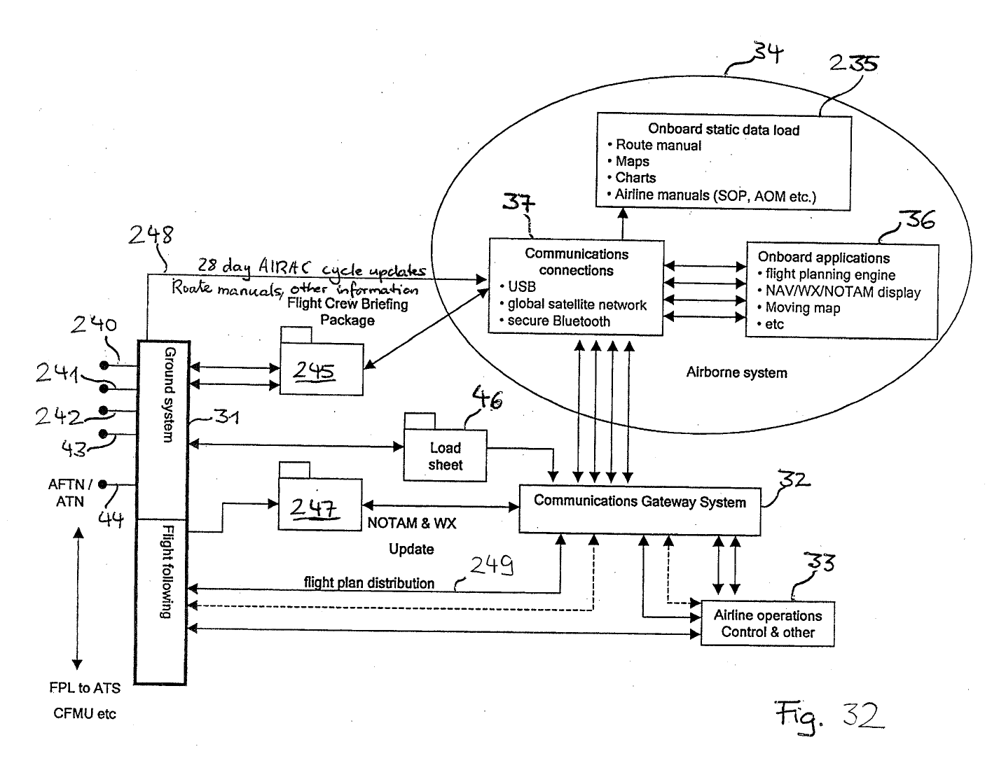

FIG. 32 illustrates a data exchange diagram of the flight information system of FIG. 31, and

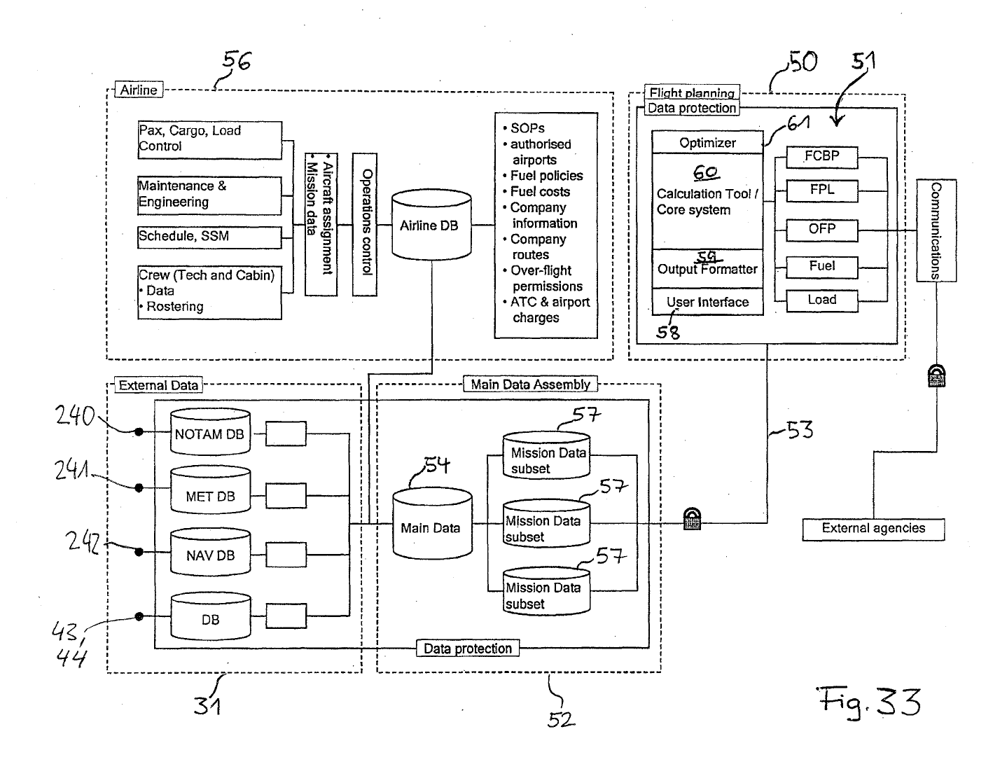

FIG. 33 illustrates a data exchange diagram of the flight information system.

In the following description, details are provided to describe embodiments of the application with accompanying figures. It shall be apparent to one skilled in the art, however, that the embodiments may be practised without such details. These figures comprise parts that have same reference numbers. Description of these parts is hereby incorporated by reference.

FIGS. 1-11 provide a first embodiment of the application. In particular, FIG. 1 illustrates an exploded view of an aeronautical input/output device 70. The input/output device 70 incorporates a touch-screen display unit 90 and a keyboard unit 91 that are detachable from each other. The touch-screen display unit 90 forms a part of the input/output device 70. FIG. 2 illustrates a side view of the input/output device 70 where the keyboard unit 91 is attached to the touch-screen display unit 90.

As shown in both FIGS. 1 and 2, the touch screen display unit 90 has a metal housing 97, which is also known as a housing. The metal housing 97 resembles a slab with two opposite sides 72, 73. The two opposite sides 72, 73 consist of a display side 72 and a mounting side 73 respectively. The display side 72 comprises a touch sensitive screen 71, which is flat and covers substantially the entire display side 72. The touch sensitive screen 71 is also known as a display screen. The mounting side 73 comprises a heat dissipation area 74 and a keyboard stowage area 87. The heat dissipation area 74 and the keyboard stowage area 87 are contiguous to each other and each of them occupies about half of the mounting side 73. The mounting side 73 comprises a tube shaped protrusion for mounting the display unit 90 in a cockpit of an aircraft 211, which is shown schematically in FIG. 31.

The heat dissipation area 74 includes two arrays of cooling fins 47, 48 that are spaced apart from each other. The two arrays of cooling fins 47, 48 comprise a first array 47 and a second array 48, which are also visible in FIG. 3. The cooling fins 47, 48 extend perpendicularly from the mounting side 73 as parallel strips. The mounting side 73 also comprises a platform 79 that is provided between the first array of the cooling fins 47 and the second array of cooling fins 48. The platform 79 has an on-off switch 75 at its centre for turning on and off the touch screen display unit 90.

The keyboard stowage area 87 has an elongated concave pocket surrounded by three keyboard guide rails 76, 77, 78. The three keyboard guide rails 76, 77, 78 include a first curved guide rail 76, an elongated guide rail 77 and a second curved guide rail 78 that are sequentially connected.

In particular, the elongated guide rail 77 divides the mounting side 73 into the heat dissipation area 74 and the keyboard stowage area 87. In a middle position of the elongated guide rail 77, the touch-screen display unit 90 has a display keyboard charging socket 89 with two metal tubes. The keyboard stowage area 87 is surrounded by the three guiding rails 76, 77, 78 at the left, upper and right side, respectively and is open from below at an opening side 88. Two slots on the keyboard unit 91 which are not shown in this figure can be inserted into the curved guide rails 76, 78, respectively, such that the keyboard unit 91 can be slid into and out of the keyboard stowage area 87 for usage. The opening side 88 is on an opposite side of the elongated guide rail 77. A retractable catch 103 is mounted at a middle position of the opening side 88.

The keyboard unit 91 is shaped like a bar whose length extends between the two opposite curved guide rails 76, 78 when attached to the touch-screen display unit 90. Referring to FIG. 4, the keyboard unit 91 comprises a keyboard housing 82 with two opposite sides. As shown in FIG. 4, the two opposite sides consist of an arched side 93 and a flat side 94. The arched side 93 has a convex profile that matches the concave shape of the keyboard stowage area 87. When assembled together, the keyboard unit 91 can be closely fitted into the keyboard stowage area 87 as shown in FIG. 2. On the flat side 94, which is best seen in FIG. 5, two leg rest cavities 95, 96 are distributed over the length of the keyboard unit 91. The two leg rest cavities 95, 96 consist of a first leg rest cavity 95 and a second leg rest cavity 96 that have generally curved shapes designed to fit over the lower thighs respectively. The two leg rest cavities 95, 96 are cavities that enable the keyboard unit 91 to rest comfortably on the thighs of a user when the user in a seated position.

Referring to FIG. 5, two catches are enclosed at two corners of the keyboard unit 91 as keyboard locking devices 85, 101 respectively. A first keyboard locking device 85 is provided at one of the corners that corresponds to a position of the first display unit locker 98 (see FIG. 1) when the keyboard unit 91 is received in the keyboard stowage area 87. Similarly, a second keyboard locker 101 is provided at another of the corners that corresponds to a position of the second display unit locker 99. Both the keyboard locking devices 85, 101 and the two leg rest cavities 95, 96 are visible in FIG. 5, which illustrates a back view of the keyboard unit 91.

The arched side 93 is provided at a front side of the keyboard unit 91, which can be better seen in FIG. 4. FIG. 4 illustrates a perspective view of the keyboard unit 91. A side screen viewer 80 and a keypad 84 are arranged side by side on the front side 93 of the keyboard unit 91. The side screen viewer 80 is also known as a display screen. The keypad 84 includes several rows of keys representing letters of alphabets, numerical digits and various extra functions. The side screen viewer 80 provides a touch-screen display for user interaction. A biometric device 83 is provided next to the side screen viewer 80. A keyboard charging plug 81 is located on an edge of the keyboard unit 91 in a middle position. The keyboard charging plug 81 has two projecting pins that are receivable by the two metal tubes of the keyboard charging socket 89.

The biometric device 83 is used as a user recognition device for authentication of users into the aircraft-based component of a flight information system. The flight information system is shown in the FIGS. 31 to 33. It is also referred to as “advanced mission display system” (AMDS). The biometric device 83 may be designed as fingerprint sensor and may comprise one or more sensors. Possible sensor types of the sensors include optical, capacitive and ultrasonic sensors. Passive and especially active capacitive sensors provide the advantage of being less sensitive to surface contaminations than optical sensors. At present, ultrasound detectors are more data intensive and complex compared to other sensor types but provide good robustness to surface conditions. Further sensor types comprise a piezoelectric pressure sensor, a radiofrequency sensor or also a thermal sensor.

In a further embodiment of the keyboard unit 91, the keyboard unit 91 comprises a fingerprint sensor 83 at a rear side of the keyboard housing 82 which is still accessible when the keyboard unit 91 is stowed on the rear side of the display unit 90. The keyboard unit 91 and/or the display unit 90 comprise means for evaluating the finger print and for releasing an electric lock of the keyboard unit 91 if the finger print is found in a fingerprint database.

The biometric device 83 provides a recognition of authorised users. A master list of authorised users is held in the airline database 56 which is connected to the main data assembly 52 in the ground-based component of the AMDS. The Data in the main data assembly 52 is synchronised with the aircraft-based system 34 using communications connections 37 or the Bluetooth data link 222. The biometric device 83 within the keyboard unit 91 of the aircraft-based system 34 can be connected to an onboard database which holds a listing of authorised users who may access the aircraft based system 34. The database on the aircraft-based system 34 may be updated and synchronised with the ground-based component using communications connections 37 or the Bluetooth data link 222.

The aeronautic input/output device 70 comprises means for evaluating the finger print and for releasing an electric lock of the keyboard unit 91 if the finger print is found in a fingerprint database. According to an embodiment of the fingerprint evaluation means, an application and/or a circuitry in the keyboard unit 91 is configured to read out sensor signals from the fingerprint sensor 83 and to convert them into a fingerprint image in a binary format. According to a first alternative, the keyboard unit 91 comprises software and/or circuitry which is configured to sent the fingerprint image to the display unit 90. The keyboard unit 91 may furthermore comprise encryption means for encrypting the fingerprint image. The display unit 90 comprises an evaluation software and/or circuitry for evaluating the biometric data, for example for the correlation of an acquired fingerprint from the biometric sensor 83 with fingerprint images in an authorized users list 24, or for the extraction of biometric data, such as minutiae and/or ridge data and for comparing the biometric data with biometric data in the authorized users list 24.

According to a second alternative, the keyboard unit 91 comprises evaluation means such as software and/or circuitry for evaluating the fingerprint. The evaluation means may comprise means for image processing, subsequent extraction of biometric data such as minutiae and/or ridge data and for converting the biometric data into a binary exchange format such as a binary number. Furthermore, the keyboard unit 91 comprises means for sending the biometric data to the display unit 90. The display unit 90 comprises identification means for comparing the biometric data with stored biometric data in an authorized users list 24. Preferentially, the authorized users list 24 is stored in an encrypted format in a computer readable memory of the display unit 90 which cannot easily be removed from the cockpit, rather than in the keyboard unit 91. When the authorized users list 24 is synchronized with a master list of crew members that is contained in the main database 54 of the main data assembly 52, only data from crew members which are associated with the current mission data subset 57 is transferred to the aircraft 211.

The touch-screen display unit 90 functions both as a computer terminal and as a display panel. The touch-screen display unit 90 incorporates computer processing units, solid-state memory, printed circuit boards, and other electronic circuitries that are connected to each other. In other words, the touch-screen display unit 90 has computing functions and is installed with an operating system for running multiple different applications to assist the flight management activities undertaken by pilots. The touch-screen display unit 90 provides a repository for manuals and documents including Aircraft Operating Manuals, Flight Crew Operating Manuals, Navigational Charts and other electronic documents as well as onboard applications 36 (see FIG. 6).

A computer readable memory of the touch-screen display unit 90 further comprises purpose-built software applications to automate other functions normally conducted manually, such as performance take-off calculations, or functions normally conducted on the ground, such as flight planning and preparation and presentation of a flight crew briefing package. When powered up, the touch-screen display unit 90 communicates with an aircraft-based system 34 and a ground-based system 35 continuously (see FIG. 6). The touch-screen display unit 90 further communicates with the keyboard unit 91 via the Bluetooth.

The input/output device 70 contains an antenna 185 for receipt and transmission of radio signals to and from the aircraft. The antenna may be placed at different positions of the unit, so as to optimize the signal reception in the cockpit environment. Furthermore, the casing 82 of the keyboard unit 91 comprises an antenna and electronic circuitry for communication with the display unit 90. The antenna, the circuitry and other components inside the casing 82 are not shown in the Figures.

The input/output device 70 may include the capability to display video signals from the cockpit or from the cabin surveillance cameras.

In addition, the touch-screen display unit 90 charges a battery (not shown) of the keyboard unit 91 when the keyboard charging socket 89 is coupled to the keyboard charging plug 81. The plug 81 and the socket 89 are connected when the keyboard unit 91 is securely received into the keyboard stowage area 87, as shown in FIG. 2. The input/output device 70 is fitted with universal serial bus (USB) ports that allow for the manual transfer of secure electronic data between a user and the input/out device 70. The USB ports are used to upload data, including flight plans, pilot briefing materials, updated versions of electronic manuals and documents. The USB ports are also used to download data, such as a completed voyage report or engineering data from the input/output device 70. The USB ports are further used to load new applications or to make changes to the onboard applications 36 in the input/output device 70.

The input/output device unit 70 utilises the display screen 71 to display graphics and text to pilots and other users. The display screen 71 can detect the presence and location of a finger touch within its display area. The pilot can touch the display screen 71 with his fingers or with a stylus such that the touch-screen display unit 90 receives inputs from the pilots for using the onboard applications 36 (see FIG. 6) in the unit 90. The display screen 71 provides an intuitive interface for interaction between the input/output device 70 and users of the input/output device 70.

A virtual keypad that is displayed on the display screen 71 and on the keypad 84 are user interfaces that can be used to make entries into the onboard applications 36 from the flight crews. For example, the keyboard unit 91 receives the entries for the flight planning system 51, or for in-flight reporting, or for messaging using the aircraft-based communication connections 37 (see FIG. 8).

The input/output device 70 contains the onboard applications 36 for electronic messaging. The electronic messaging sent to and from the pilot terminal unit 70 are processed through the aircraft communications connections 37 via the secure communication connections 21 to a ground-based communications gateway 32 (see FIG. 6).

The metal housing 97 is hermetically sealed for protecting its interior electronic components. The metal housing 97 is able to withstand repeated decompression and compression of air in the cockpit, to withstand variations in temperature, and to withstand rapid acceleration and deceleration during numerous flights. The metal housing 97 makes the touch-screen display unit 90 impervious to the ingress of liquids should these be spilled onto the touch-screen display unit 90. Both the metal housing 97 and the cooling fins 47, 48 are made out of an aluminium alloy that has high thermal conductivity for efficient heat dissipation. The aluminium alloy further provides structural protection and has the benefit of lightweight. The external surface of the metal housing 97 is painted in a colour such that the metal housing 97 absorbs little heat from the sun's radiation and to match with interior colour scheme of the cockpit.

The platform 97 is a convenient platform that holds the on-off switch 75. The top of the touch-screen display unit 90 is fitted with the ON/OFF switch 75 which is mounted on the platform 79 and is used to turn the input/output device 70 on and off. The ON/OFF switch 75 has a luminous background to aid users when the cockpit lighting environment is poor. The top and the front of the touch-screen display unit 90 is fitted with ambient light sensors 203 which are used to automatically adjust the brightness of the display screen 71 to suit the environmental lighting conditions in the cockpit.

The front of the pilot terminal unit 70 has two LEDs (light-emitting diode) 160 in the front surround. These LEDs 160 are used to indicate to the flight crews that a message of other information has been received by the aircraft-based component and is available for viewing by the flight crew. The onboard applications 36 cause the LEDs 160 to show different colours and flashing sequences for different message types.

The cooling fins 47, 48 take up heat from the metal housing 97 and conduct or radiate it to its surroundings. The aluminium alloy that makes up the metal housing 97 and the cooling fins 47, 48 further enhances heat dissipation due to its high thermal conductivity. The aluminium alloy is also light in weight so that it helps to reduce overall weight of the input/output device 70.

The curved guiding rails 76, 78 and the elongated guide rail 77 provide boundaries to the keyboard stowage area 87 for receiving the keyboard unit 91. The touch-screen display unit 90 can charge the battery inside the keyboard unit 91 via the plug 81 and the socket 89.

The keyboard locking devices 85, 101 and the input/output device locking connections 98, 99 are connected to each other in the assembled position. These locking devices 85, 98, 99, 101 hold the keyboard unit 91 with the touch-screen display unit 90 together so that the input/output device 70 has a compact slab form such that the keyboard unit 91 is flush with the metal housing 97 in the assembled position. The assembled input/output device 70 occupies little space in the cockpit.

The first leg rest cavity 95 and the second leg rest cavity 96 of the keyboard unit 91 provide ergonomic contact regions for locating the keyboard unit 91 onto a pilot's knees. When in use, the keyboard unit 91 is taken away from the display display unit 71 and rests on the thighs of the pilot. The two leg rest cavities 95, 96 serve as leg rests for laying the keyboard unit 91 flat on the pilot's thighs. The two leg rest cavities 95, 96 prevent wobbling of the keyboard unit 91 such that the pilot can have a stable platform for data entry.

The side screen viewer 80 on the keyboard unit 91 provides an additional display area for the pilot. When typing on the keyboard unit 91, the pilot can view the rows of buttons on the keypad 84 and the side screen viewer 80 simultaneously without turning his head aside away from the keypad 84. Especially, when the input/output device unit 91 is mounted at a side of the pilot, the pilot can read images on the side screen viewer 80 directly, not looking away from his typing hands. In the mean time, the pilot can look at instruments in front of him without having to turn his head.

The biometric device 83 enables applications within the input/output device 70 to identify authorised users by recognising fingerprints that are stored in a database of the ground-based system 32 and synchronised with the input/output device 70. In particular, the biometric device 83 facilitates access management and control.

Users firstly pushes the on-off switch 75 so that the input/output device 70 is powered up or turned off. The pilot can take the keyboard unit 91 out of the keyboard stowage area 87 when the input/output device 70 is turned on and scans his fingerprints via the biometric device 83. Upon confirming an identity of the user, the input/output device 70 presents its top-level graphic user interface and the keyboard unit 91 communicates with the touch screen display unit 90. Both the display screen 71 and the side screen viewer 80 are ready for receiving inputs from the authorised pilot. In the mean time, the keypad 84 allows the authorised pilot to key in text messages or commands.

The pilot can shut down the input/output device 70 by entering in specific commands via the keyboard unit 91 or by using the on-off switch 75. The keyboard unit 91 can be slotted back into the keyboard stowage area 87 by following the curved guide rails 76, 78 at any time when the keyboard unit 91 is not required for use. The retractable catch 103 withdraws when pushed by the keyboard unit 91. When keyboard charging plug 81 is connected to the keyboard charging socket 89, the retractable catch 103 protrudes such that it upholds the keyboard unit 91 inside the keyboard stowage area 87. When in position, the keyboard locking devices 85, 101 are attached to the touch-screen screen locking connections 98, 99 such that the keyboard unit 91 is held sturdily together with the touch-screen display unit 90. FIGS. 6-11 illustrate diagrams which illustrate workflows of the aeronautical input/output device 70 taking into account an authorization via the biometric device 83. In FIGS. 6-11, flash symbols indicate the use of a radio link and/or of an external network, such as the internet. The data flow over the radio link or the external network is protected, for example by encryption.

An aircraft based system 34 comprises means for communicating with a ground-based system 35. The aircraft based system 34 comprises the pilot terminal device 90 that has an onboard main computer (not shown) with aircraft-based communication connections 37, and biometric device 83. The input/output device 70 is installed with onboard applications 36 that allow users from an authorised user list 24 to access the onboard applications 36. The onboard applications 36 provide application outputs 22 of the input/output device 70 upon authorisation 23 by the users of the authorised list 24. The input/output device 70 talks to the ground-based system 35 via secure communication connections 21.

The ground-based system 35 comprises an operations centre 31 and a ground-based communications gateway 32 that are connected to each other. The ground-based system 35 is connected to airline operations 33 and other external agencies 26 via protected data flow 21, which is secure communication connection. The ground-based system 35 is also connected to airline data 43, a database with authorised user list 24 and other data sources 25 via the protected data flow 21. The database with authorised user list 24, the other data from the airline data 43 are collectively known as airline database 56. Accesses to the ground-based system 35 and the input/output device 70 may be controlled by the use of a biometric device 27.

The biometric device 83 is used for permitting only authorised users to gain access to the aircraft-based system 34 of the input/output device 70. The biometric device 83 provides an interface for users to insert a digital signature into documents or other material generated by onboard applications 36 contained in the aircraft-based system 34. Onboard applications 36 which make use of an digital signature include, for example, an Operational Flight Plan (OFP) generated by the flight planning engine 51, and a Load Sheet and a Fuel Order which may also be generated by the flight planning engine 51 using the calculation tool 60 of the flight planning engine 51. FIG. 6 illustrates the use of identification data from the biometric device 83 by onboard applications 36. Within the scope of this application, a digitally signed document or message refers to a document or message which is derived from a content and a digital signature. In particular, the digital signature may refer to a digital representation of a biometric identifier such as raw data of a sensor or characteristic features of the raw data, like minutiae. Generally speaking, the digital representation is derived from the biometric identifier and allows a unique distinction between individuals, or at least a distinction with a high probability of uniqueness.

The digital signature may simply be appended to the content to obtain a digitally signed document. In an embodiment for generating a tamper proof signed document, a hash value or other type of checksum is generated from the content and from the biometric identifier, the hash value is encrypted with a private key of the aircraft and the encrypted hash value is included in the document.

An onboard memory comprises a list of digital signatures as part of an authorized users list 24. The onboard memory further comprises a roster database that specifies which crew member is rostered for a specific flight leg, or which persons generally are authorized to access or sign (e.g. engineering staff). An identification means is configured to compare the stored signatures of those crew members which are rostered for the present flight leg with the acquired signature and to signal an identification success if the acquired signature matches with one of the stored signatures of the authorized users list 24 within a predefined accuracy.

The load sheet and loading instructions 46 are generated using data coming from a flight planning system 51 by using a calculation tool 60 which is also known as a core system 60. At the conclusion of the authorisation process, the authorised output from an onboard application 36 may be transferred to the ground-based system 35 using the aircraft-based communications connections 37 which connect to the ground-based communications gateway 32 for distribution to airline operations and other users using protected and secure communications channels 21.

At a conclusion of the work performed by one of the onboard applications 36, the onboard application 36 provides an application output 22. The application output 22 of the application 36 may require authorisation 23, before being transferred to the ground-based operations centre 31. The authorisation 23 is connected to the authorised user list 24 to ensure a user is properly authorised. The application output 22 from the onboard applications 36 is transferred to the operation centre 31, which is a part of the ground-based system 35. The aircraft-based communication connections 37 enable the transfer via a ground-based communications gateway 32 for distribution to airline operations and other users using protected and secure communication connections 21. The authorised user can use the input/output device 70 for data entry 41, for Defect Log updates 40 such as updating or adding entries into a Defect Log 39, for making in-flight reports, or for general communications.

The flight crews can access the keypad 84 and the biometric device 83 of the keyboard unit 91 to operate an onboard application 36. The onboard flight applications 36 are accessed through the input/output device 90. The onboard flight applications 36 register and record details of the flight crews after the authorisation 23 via the biometric device 83. Personal information details of the flight crews are acknowledged and transferred to the ground-based communications gateway 32 via the aircraft-based communications connections 37. The ground-based system 35 receives the personal information details via secure communications connections 21.

FIG. 7 shows a use of the biometric device 83 in a sign-in procedure 28 to an airline crew management system by flight crews of an aircraft. The sign-in procedure 28 is used by an airline to record the flight crews on duty of a flight. A list of the flight crews on duty, which is held in the authorised user list 24, is provided by an airline database 56. The authorised user list 24 relates to aircraft schedules, types of aircraft, duty times of the flight crews, and other information from flight crew rosters. The airline information is combined with input from other data sources 25 into the main database and synchronised with the aircraft-based system 34 using the ground-based communications gateway 32 and the aircraft-based communications connections 37 or the Bluetooth data link 222.

The authorized users list 24 may be uploaded to the aircraft based system 34 or it may be generated by an onboard enrollment process. During the enrollment process, an onboard enrollment application uses data from the biometric device to generate a database entry. The enrollment application provides a password protected entry of crew data which is then used to link the biometric data to the crew data and to generate a database entry. The enrollment may be further secured by the prior insertion of a physical key, a magnetic card or a dongle. An onboard enrollment increases the usage flexibility. On the other hand, providing the biometric data exclusively via encrypted data uploads increases the security. For a ground based enrollment, the ground based system 31 and the airline offices 20 may provide enrollment applications and means for secure communication of the biometric data.

The biometric device 83 also provides an access restriction which restricts the access to the aircraft based system of the AMDS to authorised users. The keyboard unit 91 can be locked by inserting the keyboard unit 91 into the display unit 91 or by typing a command into the keypad 84. Thereafter, the keyboard unit 91 can be unlocked again by providing a recognizable biometric feature to the biometric device 83 or by typing a password into the keypad 84. The locking state of the keyboard unit 91 may be provided by a memory state of a computer memory inside the keyboard unit 91 or inside the display unit 90, by a switch position or by a lock state of a mechanical lock.

In order to provide the unlocking functionality of keyboard unit 91, it is advantageous if the biometric device 83 of the keyboard unit 91 is accessible when the keyboard unit 91 is stored in the display unit. To this end, the biometric device 83 and/or additional biometric device may be provided at the back side of the keyboard unit 91. Alternatively, the keyboard unit 91 may have larger dimensions than the stowage area at the back of the display unit such that the biometric sensor is still accessible. The biometric sensor 83 may also be provided on a part which can be pulled out from the keyboard unit 91. In another embodiment, a biometric device 83 is placed at a side of the display unit 90 or at the top of the display unit 90. This placement can be seen in FIG. 23.

FIG. 8 illustrates a compilation process of a signed flight plan. After signing in 28, a flight crew constructs an operational flight plan (OFP) using the onboard applications 36 of the aircraft-based system 34. The flight crew constructs an operational flight plan using the flight planning system 51, which utilises calculation tools accessed through the input/output device 90. A digital signature is appended to the output of the flight planning system 51. The flight crew uses an authorisation 23 from the biometric device 83 to attach this digital signature. When the OFP has been properly authorised, the OFP (and the associated air traffic services flight plan (FPL)) may be sent to the aircraft communications connections 37 for transmission to the ground-based communications gateway 32 via secure and protected communications channels.

The ground-based communications gateway 32 further transmits the output to airline operations and other organisations 33 using the secure communications connections 21. The output is further utilised by selected external agencies 26 who assist the airline operations. The flight plan is transmitted from the ground-based communications gateway 32 via an Aeronautical Fixed Telecommunications Network (AFTN) or an Aeronautical Telecommunications Network (ATN) 44 to air traffic services and flow management units requiring the information.

FIG. 9 illustrates the generation of a fuel order 30 from the aircraft-based system 34 by using output taken from the flight planning system 51, which is a part of the onboard applications 36. The flight planning system 51 uses the calculation tools for calculating an amount of fuel required for a flight. The calculation employs optimisation tools 61 of the flight planning system 51 to obtain a more accurate estimate of the required fuel. Another onboard application 36 of the aircraft-based system 34 further makes a calculation as to the amount of fuel that the aircraft needs to be loaded with after consideration of the fuel remaining from the last flight, in consideration of the route and any restrictions or constraints the flight is expected to experience. The onboard application of the aircraft-based system 34 constructs a fuel order 30, which shows the amount of fuel required, and the locations of the aircraft where the fuel is to be loaded.

After the fuel order 30 has been constructed, the flight crew authorises the fuel order 30 by appending a digital signature to the fuel order 30. The flight crew uses the authorisation 23 from the biometric device 83 to apply this digital signature. When authorised, the fuel order 30 is passed to the aircraft-based communications connections 37 for transmission to the ground-based communications gateway 32 via the secure communications connections 21. The ground-based communications gateway 32 further transmits the fuel order 30 to the airline operations and other organisations 33 such as refuelling agent using the secure communications connections 21.

FIG. 10 shows a compilation process of a load sheet 46 according to the application. The flight crew generates a Load Sheet 46 and Loading Instructions from the aircraft based system 34 of the AMDS by using an onboard application 36. The onboard application 36 uses the optimization tools and the core system 60 accessed through user interfaces 58 which are accessed through the PTU 90 for the input of additional data required. A computerised Load Sheet application in the aircraft-based system 34 makes a calculation as to the placement of the load on the aircraft 211 with respect to the locations on the aircraft 211 that are to be loaded in a specific way.

Data for use in the Load Sheet and the Loading Instructions 46 is provided by the airline database 56, which is known as airline data source via the secure communication connections 21 to the ground-based system 35. The Load Sheet and Loading Instructions 46 enable calculation of the amount of the load for the aircraft and where the load is to be placed, for example in which loading compartment in the aircraft, which also takes into consideration the output from the optimisation tools of the flight planning system 51 and the fuel load calculated by the flight planning system 51.

When the load sheet and loading instructions 46 are constructed, the flight crew authorises the load sheet and the loading instructions 46 by appending a digital signature to the load sheet and loading instructions 46. The flight crew applies the authorisation 23 by the biometric device 83. After the authorisation 23, the load sheet and loading instructions 46 are passed to the aircraft-based communications connections 37 for transmission to the ground-based communications gateway 32 via the secure communications connections 21. The ground-based communications gateway 32 further transmits the Load Sheet 38 and the Loading Instruction 46 to the airline operations and other organisations 33, such as the Load master or Ramp Agent using the secure communication connections 21.

FIG. 11 shows the maintenance of a Defect Log 39 according to the application. The flight crew adds entries 40 to a Defect Log 39 that is held in the aircraft-based system 34. The Defect Log 39 updates and records defects affecting a particular aircraft 11. Preferentially, entries in the database are not removed or overwritten by new entries. Instead, each new entry into the Defect Log 39 is an addition, thus enabling users to view a complete record of events. Members of the flight crew update the Defect Log 39 using either the keypad 84 or an onscreen keyboard on the touch display screen 71. The Defect Log 39 is a part of the onboard applications 36. Furthermore, the Defect Log 39 may also receive automated entries into the Defect Log 39 from a quick access recorder (QAR) or from other onboard systems.

When the Defect Log 39 has been updated, the flight crew may authorise an update 40 to the Defect Log 39 by appending a digital signature to the Defect Log update 40. A mechanic assigns priorities to the Defect Log entries 40 via one of the input means. The assigned priorities depend on the severity of the defect. For example, a defect may only effect the general appearance of the aircraft, it may be scheduled for repair at the next opportunity, within a predetermined time period, at the next airport or immediately. An entry which is graded as immediate repair may require a premature landing. The mechanic provides a biometric feature to the biometric identification means which is converted into a digital representation of the biometric feature.

A digital signature is derived from the digital representation and the digital signature is stored with the database entry. Alternatively, the digital representation is first compared with entries of an authorized users list 24. If it is determined that the digital representation corresponds to an entry for an authorized user for grading defects, the change to the Defect Log 39 is accepted, a digital signature is derived from the digital representation and the digital signature is stored with the database entry 40.

After an authorisation 23, the Defect Log 39 may be passed to the aircraft-based communications connections 37 for transmitting to the ground-based communications gateway 32 via the secure communications connections 21. The prioritized entries in the Defect Log 39 are used for various purposes. According to one embodiment, a predetermined message is generated from an entry, depending on the priority of the entry and the predetermined message is sent automatically. For example, the predetermined message may be displayed on the display device 71 or it may be sent to the ground system 35.

In a modified embodiment, an onboard application 36 may require a digital or other signature to be entered before accepting an update 62 of the Defect Log 39.

FIG. 12 illustrates a front view of an input/out device 70 with a latch 104. The latch 104 is a swivel type catch. The input/output device 70 comprises a touch-screen display unit 90 and a keyboard unit 91 that are assembled together. The touch-screen display unit 90 has a display screen 71 for interacting with a pilot. In FIG. 12, the keyboard unit 91 is hidden behind the touch-screen display unit 90 such that a latch 104 is visible at bottom.

FIGS. 13 to 19 show the fastening of the keyboard unit 91 in the keyboard stowage area 87 of the display unit 90 using a latch 104.

FIG. 13 illustrates a sectioned view of the latch 104. FIG. 14 illustrates an isometric view of the handle 106 of the latch 104. The latch 104 comprises a handle 106, a stacked disk spring 108, and a Hexagon socket screw 110. The handle 106 has a semicircular portion 128 and an elongated portion 130 that are joined together. Both the semicircular portion 128 and the elongated portion 130 are firmly held inside a pocket of the bottom edge 112. The semi-circular portion 128 has a hole 116 such that a shaft 118 of the screw 110 passes through the hole 116 and is screwed into the bottom edge 112. Between a screw head 114 of the screw 110 and the semicircular portion 128, the stacked disk spring 108 is held around the shaft 118 by the screw head 114.

A bottom surface 122 of the semicircular portion 128 has a detent 124 that protrude in the form of a stud. The detent 124 is closely fitted into a recess 126 on the bottom edge 112 by spring force of the stacked disk spring 108.

The isometric view shows that the screw head 114 is fitted into the semicircular portion 128 of the handle 106 by the screw 110. A socket 120 is exposed on top of the screw head 114, but flush with a top surface of the semicircular portion 128. The elongated portion 130 of the handle 106 has a ridge 132 sticking out from a top of the handle 106. The ridge 132 extends throughout a length of the elongated portion 130 at its centre.

FIG. 15 illustrates a bottom view of the latch 104 on the input/output device 70 in a latched position. In the latched position, a bottom part of the semicircular portion 128 is positioned inside the recess such that a top part of semicircular portion 128 and the elongated portion 130 protrude outside the bottom edge 112. Moreover, the ridge 132 extends over a thickness direction of the touch-screen display unit 90 such that the elongated portion 130 contacts and holds the keyboard unit 91 inside the keyboard stowage area 87.

FIG. 16 illustrates a side view of the latch 104 on the input/output device 70 in the latched position. The elongated portion 130 projects outside the touch-screen display unit 90 and supports the keyboard unit 91 such that keyboard unit 91 is locked into the touch-screen display unit 90.

FIG. 17 illustrates a bottom view of the latch 104 on the input/output device 70 in the unlatched position. The handle 106 is rotated by 90° as compared to FIG. 16 such that the ridge 132 is parallel to a length direction of the bottom edge 112.

FIG. 18 illustrates a side view of the latch 104 on the input/output device 70 in the unlatched position.

In FIG. 18, the handle 106 is rotated by the 90° such that the handle 106 is completely hidden below the touch-screen display unit 90. The keyboard unit 91 drops below the latch 104 and the bottom edge 112 for detaching from the touch-screen display unit 90.

FIG. 19 illustrates an isometric view of the handle 106 without the screw 110. The handle 106 has a circular cavity 136 in the semi-circular portion for receiving the screw head 114. At a bottom of the circular cavity 136, a cylindrical through hole 136 is provided for receiving the shaft 118.

FIG. 20 illustrates a back view of the aeronautical input/output device 70 in an assembled position. FIG. 21 illustrates a perspective view of the aeronautical input/output device 70 from its back.

The aeronautical input/output device 70 has two USB sockets 146 for receiving two USB plugs respectively. Above the mounting side 73, a mounting stick 20 is provided which is not shown in the previous FIG. 1. The mounting stick 20 is provided for mounting the display unit 90 firmly in the cockpit of the aircraft. FIG. 22 illustrates a back view of the aeronautical input/output device 70 whose keyboard unit 91 is semi-detached.

FIG. 23 illustrates a front isometric view of the aeronautical input/output device 70 whose keyboard unit 91 is semi-detached. FIG. 23 illustrates a back isometric view of the aeronautical input/output device 70 whose keyboard unit 91 is semi-detached. FIG. 25 illustrates a front view of the aeronautical input/output device 70 whose keyboard unit 91 is semi-detached. FIG. 26 illustrates a first side view of the aeronautical input/output device 70 whose keyboard unit 91 is semi-detached. FIG. 27 illustrates a second side view of the aeronautical input/output device 70 whose keyboard unit 91 is semi-detached. FIG. 28 illustrates a top view of a touch screen display unit 90. FIG. 29 illustrates a bottom view of a touch screen display unit 90. FIG. 30 illustrates a back view of the touch screen display unit 90.

In FIG. 23, a first sensor location 161 at the top of the display 70, a second sensor location 162 at the front of the display 70 and a third sensor location 163 at the side of the display 70 are shown. According to an embodiment of the application, a fingerprint sensor 83 is provided at one of the sensor location 161, 162, 163. The first sensor location 161 or the second sensor location 162 may be provided close to the on-off switch 75 for convenience. The third sensor location 163 may be provided close to one of the USB sockets 146.

FIG. 31 shows an operational diagram of a flight information exchange system 210 which will also be referred to as advanced mission display system (AMDS).

Airborne components of the flight information system are provided on an aircraft 211. The airborne components include, among others, one or more displays, a computer, means for communication and data exchange and on board applications and data which are stored on a computer readable medium.

A first satellite communication link 212 connects the airborne components of the flight information system 210 to a satellite 213. The satellite 213 forms part of a network of satellites which are arranged to provide a global coverage of satellite communication links, such as the Iridium network. A second satellite communication link 215 is provided between a ground based system 35 and the satellite 213. The connection between the ground based system 35 and the satellite 213 may involve intermediate nodes, for example of an aeronautical telecommunication network, which are not shown in FIG. 31.

The ground based system 35 is connected to an operations support centre 31. Airport communication links 16 are provided between the ground based system 35 and airports 217. The airport communication links 216 comprise a first secure internet connection 218. Airline communication links 219 are provided between the ground based system 35 and airline offices 220. The airline communication links 219 comprise secure communications channels 21, such as a secure internet connection.

Furthermore, a Bluetooth data link 222 is provided between an antenna 223 at an airport 217 and the aircraft 211. The Bluetooth data link 222 serves to connect the aircraft 211 to the ground based system 35 via the airport communication link 216 while the aircraft 211 is on ground. Alternative embodiments of the data link 222 comprise a low range wireless area network connection or a different type of wireless personal area network connection such as ZigBee, chirp spread spectrum (CSS) or ultra wideband technology (UWB).

FIG. 32 shows a data exchange diagram of a data exchange between ground-based and airborne components of the flight information system 210. The ground-based components comprise an operations centre 31, a communications gateway 32 and airline information providers 33. An aircraft based system 34 is located on the aircraft 211, which is not shown in FIG. 32. The aircraft based system 34 comprises a storage 235 for static data, onboard applications 36 and communications connections 37. The communications connections 37 include various communication devices for establishing connections such as a USB connection, a connection via a global satellite network or a secure Bluetooth connection. Furthermore, the aircraft based system 34 comprises a connection to an internal data bus of the aircraft 211 for determining the status of the aircraft 211, for example to determine whether the engines of the aircraft 211 are running or if they are stopped. The aircraft based system 34 also comprises a graphical display and an input means for accepting user input such as a keypad or a touch screen.

The operations centre 31 has interfaces 240, 241, 242, 243 for obtaining flight navigation data, Notices to Airmen (NOTAM), weather data and airline data, respectively. A further interface 44 is provided for exchanging information via an aeronautical fixed telecommunications network (AFTN) or via an aeronautical telecommunications network (ATN). The information comprises, for example, flight plans and other air traffic services messages to air traffic services, such as change or delay messages (FPL, CHG, DLA etc to ATS), and data to and from a central flow management unit (CFMU), etc.

Various communication channels are provided for interchanging data between the operations centre 31 and the aircraft based system 34. The various types of data which are exchanged via the communication channels between the operations centre 31 and the aircraft based system 34 include, among others, flight crew briefing packages 245, load sheets 46, NOTAM and weather (WX) updates 247.

Specifically, an update channel 248 is provided for exchanging AIRAC (aeronautical information regulation and control) updates, Route Manuals and further data. A distribution channel 249 is provided for distributing flight planning data and any changes to that data to the ground based system 31 after a flight plan has been produced onboard the aircraft 211.

The ground based system 35 receives flight navigation data and information (Navdata) over the interface 240 from various sources including data and information for navigational and other purposes. A flight planning engine 51 onboard the aircraft 211 uses the flight navigation data and information to compute a flight plan for the aircraft 211.

Furthermore, the ground based system 35 receives the navigation and information from State and/or other authorized sources, such as Route Manuals. The navigation data and information comprises details relating to facilities, services, rules, regulations and procedures, locations, airspace, routes, waypoints and turning points, radio navigation aids or systems, aerodromes, terrain data and obstacles.

FIG. 33 shows a data exchange diagram of the flight information system 210 on board the aircraft 211. An onboard flight planning system 50 comprises a flight planning unit 51 which is realized as one of the onboard applications 36 the airborne system 34 of FIG. 32. The flight planning unit 51 is connected to a main data assembly 52 via a secure channel 53. A main database 54 of the main data assembly 52 is connected to an external data source 35 and an airline data source 56.

The flight planning unit 51 comprises a user interface 58, a data output interface 59, a flight planning engine 60 that includes a flight route optimizer 61. Output from the flight planning unit 51 comprises, amongst others, a flight crew briefing package which comprises an operational flight plan (OFP), NOTAM and weather information relating to the flight, the air traffic services notification of the flight, which is known as a flight plan (FPL), the operational flight plan for use by the flight crew and for distribution to the airline and to the operations centre 31, a fuel calculation and data for a fuel order, a load sheet and loading instructions.

The flight planning unit 51 obtains input data via the secure channel 53. The input data which is provided by the ground-based components to the airborne system 34 may include data published by the airline's commercial scheduling department, engineering and maintenance, crew management, loading data relating to the expected number of passengers, and expected freight and cargo load, navigational data, including over flight permissions, aircraft specific data, including the Minimum Equipment List (MEL) status of the aircraft 211, and NOTAM and weather data and information. The flight planning unit 51 uses the flight planning engine 60 to generate flight related output data from the input data. The flight related output data comprise an operational flight plan (OFP), an ATS flight plan (FPL), a flight crew briefing package (FCBP), data for a fuel order, and information for an onboard load sheet application. After generation of the flight related output data, the flight planning unit 51 publishes and distributes the flight related output data to various airborne and ground-based applications and devices.

The flight planning unit 51 comprises various modules for performing the various calculation tasks that are required for generating a flight plan. Namely, the flight planning unit 51 comprises a flight route calculation and generation module, a flight route optimization module, a fuel calculation module and a cost calculation module.

Furthermore, the flight planning unit 51 comprises a crew briefing generation module and a message generation module for generating messages in standardized output formats such as OFP and FPL formats. The data in the standardized output format may then be displayed on board and it may be transmitted to the ground based system or to air traffic services and other agencies where it can be read and processed.

Although the above description contains much specificity, this should not be construed as limiting the scope of the embodiments but merely providing illustration of the foreseeable embodiments. Especially the above stated advantages of the embodiments should not be construed as limiting the scope of the embodiments but merely to explain possible achievements if the described embodiments are put into practise. Thus, the scope of the embodiments should be determined by the claims and their equivalents, rather than by the examples given.

### REFERENCE NUMBERS

20 mounting stick
21 secure communications connections
22 application output
23 authorisation
24 authorised user list
25 other data sources
26 external agencies
27 use of biometric device
28 crew sign in
29 Operational Flight Plan
30 fuel order
31 operations centre
32 ground-based communications gateway
33 airline operations and other applications
34 aircraft-based system
35 ground-based system
36 onboard applications
37 aircraft-based communication connection
38 load sheet
39 Defect Log
40 Defect Log update
41 data entry
42 concave side
43 airline data
44 Aeronautical Fixed Telecommunications Network (AFTN) or Aeronautical Telecommunications Network (ATN)
46 load sheet and loading instructions
47 first array of cooling fins
48 second array of cooling fins
50 onboard flight planning system
51 flight planning system/engine
52 main data assembly
53 secure channel
54 main database
56 airline database
57 mission data subset
58 user interface
59 data output interface
60 calculation tool
70 aeronautical input/output device
71 display screen
72 display side
73 mounting side
74 heat dissipation area
75 on-off switch
76 first curved guide rail
77 elongated guide rail
78 second curved guide rail
79 platform
80 side screen viewer
81 keyboard charging plug
82 keyboard housing
83 biometric device
84 keypad
85 first keyboard locking device
87 keyboard stowage area
88 opening side
89 keyboard charging socket
90 touch-screen display unit
91 keyboard unit
93 arched side
94 flat side
95 first leg rest cavity
96 second leg rest cavity
97 metal housing
98 first locking connection
99 second locking connection
101 second keyboard locking device
103 retractable catch
104 latch
106 handle
108 stacked disk spring
110 screw
112 bottom edge
114 screw head
116 hole
118 shaft
120 socket
124 detent
126 recess
128 semi-circular portion
130 elongated portion
132 ridge
134 recess
136 circular cavity
138 cylindrical portion
146 USB sockets
160 LED
161 first sensor location
162 second sensor location
163 third sensor location
185 Bluetooth antenna
203 light sensors
210 flight information system
211 aircraft
212 satellite communication link
213 satellite
215 satellite communication link
216 airport communication link
218 secure internet connection
219 airline communication links
220 airline office
222 Bluetooth data link
223 airport antenna

1. Aeronautical input/output device for flight task management comprising:
a display unit having a housing, and
a keyboard unit which is adapted to communicate with the display unit, wherein the housing comprises a keyboard stowage area for receiving the keyboard unit into the keyboard stowage area, and the keyboard unit is detachable from or attachable to the display unit,
a biometric identification means, the biometric identification means comprising a biometric sensor and an interface to a database, the biometric sensor being provided on a casing of the aeronautical input/output device and the database comprising an authorized users list, and
at least one locking device for detachably fastening the keyboard unit to the display unit, wherein the at least one locking device is configured to unlock in response to a predetermined signal of the biometric identification means.

2. Aeronautical input/output device according to claim 1, wherein the biometric identification means is configured to derive a digital representation of a biometric identifier and is furthermore configured to derive the predetermined signal from the digital representation of the biometric identifier, the biometric identifier being selected from a fingerprint, a palm pattern, a retina pattern, an iris pattern, a voice pattern or a behavioural pattern.

3. Aeronautical input/output device according to claim 1 wherein the keyboard unit comprises an antenna for establishing a radio link to the display unit, an electronic circuitry which is connected to the antenna, a rechargeable current supply which is connected to the electronic circuitry and a charging plug which is connected to the rechargeable current supply, the charging plug matching with a charging socket on the display unit.

4. Aeronautical input/output device according to claim 1, wherein the at least one locking device comprises a swivel type catch with an actuator, the actuator being connected to electronic circuitry of the aeronautical input/output device, the electronic circuitry being configured to generate the predetermined signal in response to a digital representation of a biometric identifier.

5. Aeronautical input/output device according to claim 1, wherein the at least one locking device comprises a magnetic catch with an actuator, the actuator being connected to electronic circuitry of the aeronautical input/output device, the electronic circuitry being configured to generate the predetermined signal in response to a digital representation of a biometric identifier.

6. Aeronautical input/output device according to claim 1, wherein the biometric identification means is provided at a casing of the display unit.

7. Aeronautical input/output device according to claim 1, wherein the at least one locking device is furthermore configured to lock in response to a predetermined signal of the biometric identification means.

8. Aeronautical input/output device according to claim 1, wherein the keyboard stowage area comprises a concave side and the keyboard housing comprises a convex side, the convex side and the concave side comprising an essentially mating shape.

9. Aeronautical input/output system comprising an aeronautical input/output device according to claim 1, wherein the aeronautical input/output system comprises at least one data processing unit and at least one computer readable memory, the computer readable memory comprising the database with the authorized users list, the data processing unit and the computer readable memory being connectable to each other and at least one data entry of the authorized users list comprising a digital representation of a biometric identifier.

10. Aeronautical input/output system according to claim 9, wherein the data processing unit and the computer readable memory are provided in the housing of the display unit.

11. Aeronautical input/output system according to claim 9, the aeronautic input/output system comprising means for updating the authorized users list with a ground based system.

12. Method for generating a signed entry in a defect log of an aircraft, the method comprising:
receiving an entry to the defect log via an aeronautic input/output device;
adding the entry to the defect log;
receiving a priority grading of the entry via the aeronautic input/output device;
receiving a predetermined digital representation of a biometric feature via a biometric sensor; and
deriving a signed priority grading from the priority grading and the digital representation and storing the signed priority grading with the entry in the defect log.

13. Method for generating a signed entry in a defect log of an aircraft according to claim 12, further comprising
receiving a predetermined digital representation of a second biometric feature via the biometric sensor;
wherein the step of adding the entry to the defect log further comprises
deriving a signed entry from the entry and the digital representation of the second biometric feature; and
adding the signed entry to the defect log.

14. Method for distributing a digitally signed load and balance sheet from an aircraft, comprising
receiving loading data from a ground based airline office;
using an onboard application to generate a load sheet;
receiving a predetermined digital representation of a biometric feature via, a biometric sensor;
generating a digitally signed load and balance sheet using the digital representation of the biometric feature; and
passing the digitally signed load and balance sheet to aircraft based communication means.

15. Method for distributing a digitally signed fuel order from an aircraft, comprising
using an onboard application to calculate a required amount of fuel;
receiving a predetermined digital representation of a biometric feature via a biometric sensor;
generating a digitally signed fuel order using the digital representation of the biometric feature; and
passing the digitally signed fuel order to communication means of the aircraft.

16. Method for unlocking a keyboard unit from a display unit of an aeronautical input/output device, comprising
deriving a predetermined digital representation of a biometric feature from an input signal of a biometric sensor, the biometric sensor being provided at a casing of the aeronautical input/output device;
comparing the digital representation with entries of an authorized user list in a computer readable memory; and
responsive to the digital representation matching an entry of the authorized users list
actuating an actuator of a locking device of the keyboard unit to unlock the keyboard unit.
